(19) United States
(12) Patent Application Publication
(10) Pub. No.: US 2018/0300455 A1
(43) Pub. Date: Oct. 18, 2018

(54) CHAIN OF CUSTODY FOR BIOLOGICAL SAMPLES AND BIOLOGICAL MATERIAL USED IN GENOTYPING TESTS

(71) Applicant: Orig3n, Inc., Boston, MA (US)

(72) Inventors: Robin Y. Smith, Boston, MA (US); Sunil Anant Gupta, Boston, MA (US); Kate Blanchard, Boston, MA (US); Edward Joseph Coffey, Boston, MA (US); Marcie A. Glicksman, Boston, MA (US)

(21) Appl. No.: 15/846,659

(22) Filed: Dec. 19, 2017

Related U.S. Application Data
(60) Provisional application No. 62/485,778, filed on Apr. 14, 2017.

(51) Int. Cl. G06F 19/26; G06F 19/18; G01N 35/00

(52) U.S. Cl. CPC G06F 19/26; G06F 19/18; G01N 2035/0091; G01N 2035/00831; G01N 2035/00752; G01N 35/00732

(57) ABSTRACT

Described herein are systems and methods to record and track, via a graphical user interface, biological samples, and biological material extracted therefrom, used to generate genotyping data. As biological samples are processed in several stages to extract biological material and perform genotyping tests, IDs are assigned to biological samples and biological material for individuals as well as well plates used during processing of the biological samples and the biological material in order to organize the samples and the tests. Biological samples are assigned to well plates for use in extracting biological material. Biological material is assigned to genotyping plates for use in performing genotyping tests. By associating IDs corresponding to biological samples or biological material with IDs for well plates or genotyping plates, respectively, a user can track which extractions and/or tests need to be performed and record which biological samples have been received or genotyping plates analyzed.

### CROSS REFERENCE TO RELATED APPLICATIONS

This application claims the benefit of U.S. Provisional Application No. 62/485,778, filed Apr. 14, 2017, the contents of which are hereby incorporated by reference herein in their entirety

### FIELD

The present disclosure relates generally to systems and methods to record and track biological samples used to generate genotyping data.

### BACKGROUND

Genomes hold much valuable information that can be used to better understand biological characteristics and traits of humans and animals. Genotyping individuals or animals can provide useful information for use in academic, medical, or personal contexts. Biological samples are genotyped in academic research to understand the relationship between genomes and phenotypes or biological processes. Biological samples are genotyped by physicians for diagnostic purposes. Recently, individuals have begun to use personal genotyping data to understand implications of their genomes on their health and personal attributes. Developing an understanding of a genome through genotyping can provide valuable information that may be used in developing scientific understanding, treating patients, or making decisions about one's behavior and habits.

Until recently, characterizing a genome was prohibitively expensive such that very few individual genomes had been fully or even partially characterized. Techniques utilized in genotyping a genome required significant resources that limited genotyping to selective laboratory use in highly centralized scientific research. Developments of cost-effective equipment and procedures for genotyping have made high-throughput genotyping feasible. The output of genetic information from such genotyping procedures still requires expertise in the biological sciences to understand. Thus, genotyping is still handled by laboratories, firms, or healthcare facilities that specialize in genetic experimentation on biological samples.

At present, many links between the human genome and biological characteristics, traits, and processes exist in addition to new relationships being researched contemporarily. Often these relationships are complex such that for a given set of related biological characteristics, many genes or single nucleotide polymorphisms (SNPs) within the genes are responsible for defining a relationship for a particular individual. Likewise, when genotyping an individual as part of a diagnostic effort or testing potential genetic influence on a biological process as part of a research study, many genes and/or SNPs are tested. Each biological sample collected from an individual may be divided many times in order to test for the large plurality of genes. Consequently, the amount of samples collected and processed for genotyping can be quite large even for moderate population sizes, whether in a hospital environment, academic institution, or industrial laboratory. Thus, there is a need for systems and methods to record and track biological samples used to generate genotyping data.

### SUMMARY

Described herein are systems and methods to record and track, via a graphical user interface, biological samples, and biological material extracted therefrom, used to generate genotyping data. As biological samples are processed in several stages to extract biological material and perform genotyping tests, IDs are assigned to biological samples and biological material for individuals as well as well plates used during processing of the biological samples and the biological material in order to organize the samples and the tests. Biological samples are assigned to well plates for use in extracting biological material. Biological material is assigned to genotyping plates for use in performing genotyping tests. By associating IDs corresponding to biological samples or biological material with IDs for well plates or genotyping plates, respectively, a user can track which extractions and/or tests need to be performed as well as record which biological samples have been received or genotyping plates analyzed via a graphical user interface.

In one aspect, the invention is directed to a method for recording and tracking biological samples and biological material used to generate genotyping data, the method comprising: receiving, by a processor of a computing device, a sample ID (e.g., corresponding to a barcode, a QR code, or a label affixed to a vial), wherein the sample ID is associated with a vial containing a biological sample and the sample ID is associated with metadata that identifies an individual; assigning, by the processor, (e.g., automatically) the biological sample to an empty well in a well plate (e.g., a 96-well plate), wherein the well plate is identified by a plate ID; generating, by the processor, an anonymous vial ID (e.g., wherein the anonymous vial ID indicates a location in an array of the well plate identified by the plate ID), wherein the anonymous vial ID corresponds to one or more vials containing biological material (e.g., DNA) that has been extracted from the biological sample; associating, by the processor, the metadata with the anonymous vial ID; and storing, by the processor, the anonymous vial ID for use in performing genotyping tests while obfuscating identity of the individual.

In certain embodiments, the method further comprises: receiving, by the processor, for each of a plurality of anonymous vial IDs, a portion of the metadata, wherein the portion of the metadata identifies a genotyping test to be performed; determining (e.g., by the processor (e.g., automatically)) a genotyping plate (e.g., a 96-well genotyping plate) to be used for performing the genotyping test based, in part, on a number of wells needed for the genotyping test (e.g., wherein the number of wells corresponds to a number of genes and/or SNPs that are measured in the genotyping test)(e.g., additionally based, at least in part, on when the genotyping test was ordered), wherein the genotyping plate is identified by a genotyping plate ID; associating, by the processor, the anonymous vial ID with the genotyping plate ID; and storing, by the processor, the genotyping plate ID for use in managing genotyping test workflow.

In certain embodiments, method further comprises: receiving, by the processor, a list of genotyping plate IDs, wherein each genotyping plate ID corresponds to an unanalyzed genotyping plate; presenting, by the processor, a graphical user interface element (e.g., a widget) that displays the list (e.g., wherein the list is displayed in a reverse chronological order (e.g., based on when the biological material was extracted or when the genotyping test was ordered)); receiving, by the processor, via a graphical control element in the graphical user interface element, input that indicates at least one genotyping plate has been analyzed, wherein the at least one genotyping plate corresponds to one or more genotyping plate IDs in the list; and removing, by the processor, the genotyping plate ID from the list.

In certain embodiments, the method comprises: presenting, by the processor, a graphical user interface element (e.g., a widget) for recording a received biological sample, the graphical user interface element comprising: a graphical control element for user entry of a sample ID (e.g., by scanning a barcode), and a plurality of individual metadata graphical control elements for entering information about the individual corresponding to the biological sample identified by the sample ID; and receiving, by the processor, via the graphical user interface element, the sample ID and the metadata.

In certain embodiments, the method comprises automatically filling, by the processor, at least a portion of the plurality of individual metadata graphical control elements based on a profile registration of the individual; and

In certain embodiments, the method comprises: automatically sending, by the processor, subsequent to receiving the sample ID, an email to the individual to communicate to the individual that the biological sample has been received.

In certain embodiments, the method comprises: automatically sending, by the processor, subsequent to assigning the biological sample, an email to the individual to communicate to the individual that the biological sample is being processed.

In certain embodiments, the method comprises: populating, by the processor, the email with one or more genotyping tests that will be performed for the individual.

In certain embodiments, the method comprises: presenting, by the processor, a graphical user interface element (e.g., widget) for assigning biological samples to empty wells in a well plate in order to extract biological material from the biological samples, wherein the graphical user interface element comprises: a graphical control element for user entry of a plate ID, a graphical control element for user entry of sample IDs (e.g., by scanning a barcode); receiving, by the processor, via the graphical user interface element, the sample ID; indicating, by the processor, on the graphical user interface element, that the biological sample corresponding to the sample ID has been assigned to the empty well (e.g., by filling in a graphical array representing the well plate (e.g., with the sample ID)); and indicating, by the processor, on the graphical user interface element, a number of empty wells remaining in the well plate.

In certain embodiments, the method comprises: presenting, by the processor, a graphical user interface element for assigning biological material corresponding to an anonymous vial ID to one or more wells in a genotyping plate, the graphical user interface element comprising: a graphical control element for user selection of a genotyping test, and a graphical control element for user entry of a genotyping plate ID; displaying, by the processor, via the graphical user interface element, a list of anonymous vial IDs and a list of genotyping tests associated with the list of anonymous vial IDs (e.g., wherein the lists are displayed in a reverse chronological order (e.g., based on when the biological material was extracted or when the genotyping test was ordered)); and receiving, by the processor, via the graphical user interface element, the genotyping plate ID.

In certain embodiments, the method comprises: determining, by the processor, one or more empty wells in the genotyping plate; and indicating, by the processor, via a graphical user interface element, the location of the one or more empty wells in the genotyping plate.

In certain embodiments, the method comprises: automatically sending, by the processor, subsequent to determining the genotyping plate, an email to the individual to communicate to the individual that genotyping testing is being performed.

In certain embodiments, the at least one genotyping plate has been analyzed when the genotyping plate has been tested and resulting data determined to be of sufficient quality.

In certain embodiments, the genotyping test corresponds to a personal genetic profile product (e.g., corresponding to an assessment purchased by the individual)(e.g., used for creation of a personal genetic profile assessment for the individual; e.g., wherein the genotyping test measures a specific set of a plurality of SNPs, wherein the specific set is associated the personal genetic profile product to which the genotyping test corresponds; e.g., such that the personal genetic profile product serves as a template for automated creation and presentation to the individual of the results of the genotyping measurements of the specific set of SNPs).

In another aspect, the invention is directed to a system for recording and tracking biological samples and biological material used to generate genotyping data, the system comprising: a processor; a non-transitory computer readable memory having instructions stored thereon, wherein the instructions, when executed by the processor, cause the processor to: receive a sample ID (e.g., corresponding to a barcode, a QR code, or a label affixed to a vial), wherein the sample ID is associated with a vial containing a biological sample and the sample ID is associated with metadata that identifies an individual; assign (e.g., automatically) the biological sample to an empty well in a well plate (e.g., a 96-well plate), wherein the well plate is identified by a plate ID; generate an anonymous vial ID (e.g., wherein the anonymous vial ID indicates a location in an array of the well plate identified by the plate ID), wherein the anonymous vial ID corresponds to one or more vials containing biological material (e.g., DNA) that has been extracted from the biological sample; associate the metadata with the anonymous vial ID; and store the anonymous vial ID for use in performing genotyping tests while obfuscating identity of the individual.

In certain embodiments, the instructions cause the processor to: receive, for each of a plurality of anonymous vial IDs, a portion of the metadata, wherein the portion of the metadata identifies a genotyping test to be performed; determine (e.g., automatically) a genotyping plate (e.g., a 96-well genotyping plate) to be used for performing the genotyping test based, in part, on a number of wells needed for the genotyping test (e.g., wherein the number of wells corresponds to a number of genes and/or SNPs that are measured in the genotyping test)(e.g., additionally based, at least in part, on when the genotyping test was ordered), wherein the genotyping plate is identified by a genotyping plate ID; associate the anonymous vial ID with the genotyping plate ID; and store the genotyping plate ID for use in managing genotyping test workflow.

In certain embodiments, the instructions cause the processor to: receive a list of genotyping plate IDs, wherein each genotyping plate ID corresponds to an unanalyzed genotyping plate; cause presentation of a graphical user interface element (e.g., a widget) that displays the list (e.g., wherein the list is displayed in a reverse chronological order (e.g., based on when the biological material was extracted or when the genotyping test was ordered)); receive, via a graphical control element in the graphical user interface element, input that indicates at least one genotyping plate has been analyzed, wherein the at least one genotyping plate corresponds to one or more genotyping plate IDs in the list; and remove the genotyping plate ID from the list.

In certain embodiments, the instructions cause the processor to: cause presentation of a graphical user interface element (e.g., a widget) for recording a received biological sample, the graphical user interface element comprising: a graphical control element for user entry of a sample ID (e.g., by scanning a barcode), and a plurality of individual metadata graphical control elements for entering information about the individual corresponding to the biological sample identified by the sample ID; and receive, via the graphical user interface element, the sample ID and the metadata.

In certain embodiments, the instructions cause the processor to automatically fill at least a portion of the plurality of individual metadata graphical control elements based on a profile registration of the individual.

In certain embodiments, the instructions cause the processor to: automatically send, subsequent to receiving the sample ID, an email to the individual to communicate to the individual that the biological sample has been received.

In certain embodiments, the instructions cause the processor to: automatically send, subsequent to assigning the biological sample, an email to the individual to communicate to the individual that the biological sample is being processed.

In certain embodiments, the instructions cause the processor to: populate the email with one or more genotyping tests that will be performed for the individual.

In certain embodiments, the instructions cause the processor to: cause presentation of a graphical user interface element (e.g., widget) for assigning biological samples to empty wells in a well plate in order to extract biological material from the biological samples, wherein the graphical user interface element comprises: a graphical control element for user entry of a plate ID, a graphical control element for user entry of sample IDs (e.g., by scanning a barcode); receive, via the graphical user interface element, the sample ID; cause indication, on the graphical user interface element, that the biological sample corresponding to the sample ID has been assigned to the empty well (e.g., by filling in a graphical array representing the well plate (e.g., with the sample ID)); and cause indication, on the graphical user interface element, of a number of empty wells remaining in the well plate.

In certain embodiments, the instructions cause the processor to: cause presentation of a graphical user interface element for assigning biological material corresponding to an anonymous vial ID to one or more wells in a genotyping plate, the graphical user interface element comprising: a graphical control element for user selection of a genotyping test, and a graphical control element for user entry of a genotyping plate ID; cause display of, via the graphical user interface element, a list of anonymous vial IDs and a list of genotyping tests associated with the list of anonymous vial IDs (e.g., wherein the lists are displayed in a reverse chronological order (e.g., based on when the biological material was extracted or when the genotyping test was ordered)); and receive, via the graphical user interface element, the genotyping plate ID.

In certain embodiments, the instructions cause the processor to: determine, one or more empty wells in the genotyping plate; and cause indication, via a graphical user interface element, of the location of the one or more empty wells in the genotyping plate.

In certain embodiments, the instructions cause the processor to: automatically send, subsequent to determining the genotyping plate, an email to the individual to communicate to the individual that genotyping testing is being performed.

In certain embodiments, the at least one genotyping plate has been analyzed when the genotyping plate has been tested and resulting data determined to be of sufficient quality.

In certain embodiments, the genotyping test corresponds to a personal genetic profile product (e.g., corresponding to an assessment purchased by the individual)(e.g., used for creation of a personal genetic profile assessment for the individual; e.g., wherein the genotyping test measures a specific set of a plurality of SNPs, wherein the specific set is associated the personal genetic profile product to which the genotyping test corresponds; e.g., such that the personal genetic profile product serves as a template for automated creation and presentation to the individual of the results of the genotyping measurements of the specific set of SNPs).

### Definitions

In order for the present disclosure to be more readily understood, certain terms used herein are defined below. Additional definitions for the following terms and other terms may be set forth throughout the specification.

In this application, the use of “or” means “and/or” unless stated otherwise. As used in this application, the term “comprise” and variations of the term, such as “comprising” and “comprises,” are not intended to exclude other additives, components, integers or steps. As used in this application, the terms “about” and “approximately” are used as equivalents. Any numerals used in this application with or without about/approximately are meant to cover any normal fluctuations appreciated by one of ordinary skill in the relevant art. In certain embodiments, the term “approximately” or “about” refers to a range of values that fall within 25%, 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value).

Product, Genetic Profile Product, Personal Genetic Profile Product: As used herein, the terms “product,” “genetic profile product,” and “personal genetic profile product,” refer to a data structure corresponding to (e.g. that is used to represent) a general class of health-related traits and/or characteristics. In certain embodiments a product is associated with one or more categories that correspond to health-related traits and characteristics related to the general class of health-related traits and characteristics to which the product corresponds.

Graphical Control Element: As used herein, the term “graphical control element” refers to an element of a graphical user interface element (e.g., widget) that may be used to provide user and/or individual input. A graphical control element may be a textbox, dropdown list, radio button, data field, checkbox, button (e.g., selectable icon), list box, or slider.

Associate, Associated with: As used herein, the terms “associate,” and “associated with,” as in a first data structure is associated with a second data structure, refer to a computer representation of an association between two data structures or data elements that is stored electronically (e.g. in computer memory).

Genotyping test: As used herein, the term “genotyping test” refers to a set of genotyping measurements used to determine information about an individual's genotype. A genotyping test is performed to measure one or more genes and/or SNPs.

Genotyping data: As used herein, the term “genotyping data” refers to data obtained from measurements of a genotype. Measurements of a genotype performed on a biological sample identify the particular nucleotide(s) (also referred to as “bases”) that is/are incorporated at one or more particular positions in genetic material extracted from the biological sample. Accordingly, genotyping measurements for a particular individual are measurements performed on a biological sample of from the individual, and which identify the particular nucleotides present at one or more specific positions within their genome.

Genotyping data may be measurements of particular genes, or SNPs. For example, a genotyping measurement of a particular SNP for an individual identifies the particular variant of that SNP that the individual has. A genotyping measurement of a particular gene for an individual identifies the particular nucleotides that are present at one or more locations within and/or in proximity to the gene for the individual. For example, genotyping measurements of a particular gene may identify the particular variants of one or more SNPs associated with a particular gene.

In certain embodiments, genotyping data is obtained from a multi-gene panel. In certain embodiments, genotyping data is obtained from assays (e.g., TaqMan™ assays) that detect one or more specific variants of specific SNPs. In certain embodiments, genotyping data is obtained from genetic sequencing measurements.

In certain embodiments, genotyping data is generated in response to a purchase or request by an individual. In certain embodiments, genotyping data comprises data for a portion of a genotype (e.g., of an individual). In certain embodiments, genotyping data comprises all available measurements of a genotype (e.g., of an individual).

Biological Sample: As used herein, the term “biological sample” typically refers to a sample obtained or derived from a biological source (e.g., a tissue or organism or cell culture) of interest, as described herein. In some embodiments, a source of interest comprises an organism, such as an animal or human. In some embodiments, a biological sample is or comprises biological tissue or fluid. In some embodiments, a biological sample may be or comprise bone marrow; blood; blood cells; ascites; tissue or fine needle biopsy samples; cell-containing body fluids; free floating nucleic acids; sputum; saliva; urine; cerebrospinal fluid, peritoneal fluid; pleural fluid; feces; lymph; gynecological fluids; skin swabs; vaginal swabs; oral swabs (e.g., cheek swabs); nasal swabs; washings or lavages such as a ductal lavages or bronchioalveolar lavages; aspirates; scrapings; bone marrow specimens; tissue biopsy specimens; surgical specimens; feces, other body fluids, secretions, and/or excretions; and/or cells therefrom, etc. In some embodiments, a biological sample is or comprises cells obtained from an individual. In some embodiments, obtained cells are or include cells from an individual from whom the sample is obtained. In some embodiments, a sample is a “primary sample” obtained directly from a source of interest by any appropriate means. For example, in some embodiments, a primary biological sample is obtained by methods selected from the group consisting of biopsy (e.g., fine needle aspiration or tissue biopsy), surgery, collection of body fluid (e.g., blood, lymph, feces etc.), etc. In some embodiments, as will be clear from context, the term “sample” refers to a preparation that is obtained by processing (e.g., by removing one or more components of and/or by adding one or more agents to) a primary sample. For example, filtering using a semi-permeable membrane. Such a “processed sample” may comprise, for example nucleic acids or proteins extracted from a sample or obtained by subjecting a primary sample to techniques such as isolation and/or purification of certain components, etc.

Biological material: As used herein, the term “biological material” refers to material extracted or derived from a biological sample that is used in a genotyping test or as a precursor material to a material used in a genotyping test. Biological material may be processed prior to being used to perform a genotyping test. In certain embodiments, biological material is DNA. In certain embodiments, biological material is RNA.

Individual: As used herein, the term “individual” refers to a eukaryotic organism that is the subject of a genotyping test. In certain embodiments, an individual is a human. In certain embodiments, an individual is an animal (e.g., a pet). In certain embodiments, an individual is a test subject (e.g., in an experiment). In certain embodiments, an individual is a patient. An individual may be a plant, an insect, a bacteria, or a fungus.

User: As used herein, the term “user” refers to a person who processes biological samples and/or performs genotyping tests. A user may be a laboratory technician, a scientist, a doctor, or a researcher.

### BRIEF DESCRIPTION OF THE DRAWING

Drawings are presented herein for illustration purposes, not for limitation. The foregoing and other objects, aspects, features, and advantages of the invention will become more apparent and may be better understood by referring to the following description taken in conjunction with the accompanying drawings, in which:

FIG. 1 is a block diagram of an exemplary method for recording and tracking a biological samples used for genotyping, according to an illustrative embodiment of the invention;

FIG. 2 is a screenshot of an initial menu in a graphical user interface for recording and tracking biological samples and biological material extracted therefrom, according to an illustrative embodiment of the invention;

FIG. 3 is a screenshot of a graphical user interface for recording newly received samples, according to an illustrative embodiment of the invention;

FIG. 4 is a screenshot of a graphical user interface for assigning recorded samples into a 96-well plate in order to extract DNA, according to an illustrative embodiment of the invention;

FIG. 5 is a screenshot of a graphical user interface for distributing recorded samples into a 96-well plate in order to extract DNA wherein two samples have been assigned to wells in the plate, according to an illustrative embodiment of the invention;

FIG. 6 is a screenshot of a graphical user interface for assigning recorded samples to a PCR plate, according to an illustrative embodiment of the invention;

FIG. 7 is a screenshot of a graphical user interface for assigning recorded samples to a PCR plate, according to an illustrative embodiment of the invention;

FIG. 8 is a screenshot of a graphical user interface showing recorded samples assigned to PCR plates for the FUEL™ product, according to an illustrative embodiment of the invention;

FIG. 9 is a screenshot of a graphical user interface for recording which PCR plates have been analyzed, according to an illustrative embodiment of the invention;

FIG. 10 is a block diagram of an example network environment for use in the methods and systems described herein, according to an illustrative embodiment; and

FIG. 11 is a block diagram of an example computing device and an example mobile computing device, for use in illustrative embodiments of the invention.

FIG. 12 is a block diagram illustrating associations between different data structures in a personal genetic profile product, according to an illustrative embodiment of the invention;

FIG. 13 is a block diagram showing an organizational hierarchy of a personal genetic profile product, according to an illustrative embodiment of the invention;

FIG. 14 is a block diagram showing a process for creating a personal genetic profile assessment, according to an illustrative embodiment of the invention;

FIG. 15 is a portion of a text file comprising genotyping data, according to an illustrative embodiment of the invention.

### DETAILED DESCRIPTION

It is contemplated that systems, devices, methods, and processes of the claimed invention encompass variations and adaptations developed using information from the embodiments described herein. Adaptation and/or modification of the systems, devices, methods, and processes described herein may be performed by those of ordinary skill in the relevant art.

Throughout the description, where articles, devices, and systems are described as having, including, or comprising specific components, or where processes and methods are described as having, including, or comprising specific steps, it is contemplated that, additionally, there are articles, devices, and systems of the present invention that consist essentially of, or consist of, the recited components, and that there are processes and methods according to the present invention that consist essentially of, or consist of, the recited processing steps.

It should be understood that the order of steps or order for performing certain action is immaterial so long as the invention remains operable. Moreover, two or more steps or actions may be conducted simultaneously.

The mention herein of any publication, for example, in the Background section, is not an admission that the publication serves as prior art with respect to any of the claims presented herein. The Background section is presented for purposes of clarity and is not meant as a description of prior art with respect to any claim. Headers are provided for the convenience of the reader and are not intended to be limiting with respect to the claimed subject matter.

Headers are provided for the convenience of the reader—the presence and/or placement of a header is not intended to limit the scope of the subject matter described herein.

In certain embodiments, the systems and methods described herein provide for recording and tracking biological samples that are processed and tested (e.g., via one or more genotyping tests) to generate personal genetic profile assessments for various individuals. An individual's personal genetic profile assessment stores a collection of genotyping data for the individual, along with related information, in an organized fashion. In particular, an individual's personal genetic profile assessment includes data representing the results of one or more genotyping tests for the individual. Each genotyping test measures a set of SNPs to determine, for each SNP of the set, a particular variant of the SNP that the individual has.

SNPs correspond to specific locations within or nearby genes in an individual's genetic material (e.g. a SNP may occur in a promotor region that influences transcription of a particular gene, e.g. a SNP may occur within 5 kb upstream or downstream of a particular gene, e.g. a SNP may occur within 100 kb upstream or downstream of a particular gene, e.g. a SNP may occur within 500 kb upstream or downstream of a particular gene, e.g. a SNP may occur within 1 Mb upstream or downstream of a particular gene). Accordingly, the specific variant of a particular SNP that an individual has may influence the expression of one or more genes with which the SNP is associated (e.g., occurs within or nearby) which, in turn, influences various health related phenotypes for the individual. Accordingly, performing and supplying an individual with results of genotyping tests that determine the particular variants of a various SNPs that the individual has can provide the individual with insight into how their unique genetic makeup influences their unique physical and behavioral characteristics.

Different genotyping tests may measure different sets of SNPs. In certain embodiments, the different sets of SNPs measured in different genotyping tests are selected such that a particular genotyping test measures a particular set of SNPs that all are related to (e.g., influence physical and/or behavioral characteristics related to) a general class of health-related traits and characteristics. Accordingly, an individual may have one or more genotyping tests performed to gain insight into the different ways that their genetic makeup influences their health, physical characteristics, and behavior.

In certain embodiments, to obtain their genetic test results, an individual provides a biological sample, which is received by a processing facility that extracts genetic material from the biological sample, performs one or more genotyping tests, and analyzes the results. In order to handle the creation of personal genetic profile assessments for a large number of individuals, in a quick, efficient, accurate, and secure fashion, such facilities must be able to coordinate the receipt, handling, and measurement (e.g., via genotyping) of a large number of biological samples from different individuals. The systems and methods described herein provide capabilities that facilitate this processing, while also providing for a layer of security by anonymizing biological samples during processing.

### Recording and Tracking of Biological Samples

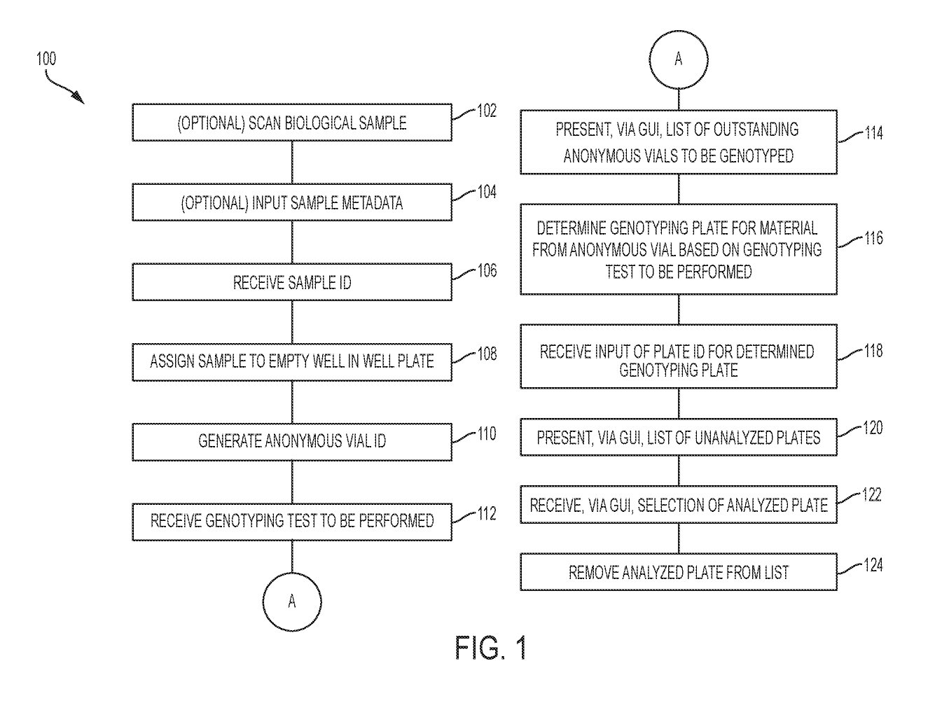

FIG. 1 is a block diagram of exemplary method 100 for recording and tracking biological sample with a computer using a graphical user interface (GUI). In optional step 102, a biological sample is scanned into a GUI presented by a processor of a computing device. Scanning the biological sample may include scanning a barcode, QR code, label, or other similar identifying mark on a vial that holds a biological sample of an individual. For example, a vial mailed to the individual for the purpose of collection of a biological sample after the individual signed up for a genotyping service. The individual may have already registered certain personal information including ordered genotyping tests at an early point such that this information is autofilled into the GUI. In optional step 104, sample metadata is input into the GUI via one or more graphical control elements, including any relevant information that identifies or characterizes the individual and any genotyping tests ordered for the individual.

In step 106, a sample ID is received via the GUI, for example, as a result of scanning a vial containing a biological sample in optional step 102. In certain embodiments, the sample ID is based on a code or identifying label on a vial containing a biological sample such that the sample ID can be easily used to verify which vial corresponds to which individual. In step 108, the processor assigns the sample corresponding to the sample ID to an empty well in a well plate that is identified by a plate ID. The samples in a well plate will be processed to extract biological material for use in genotyping tests. In step 110, an anonymous vial ID is generated by the processor, wherein the anonymous vial ID corresponds to a vial that contains biological material extracted from a biological sample (e.g., the vial is also labeled with the anonymous vial ID). In certain embodiments, the sample ID is the anonymous vial ID. For example, the anonymous vial ID may be the same as the sample ID when the sample ID does not have any personal identifying information. In certain embodiments, the anonymous vial ID is indicative of which well plate the biological sample has been assigned to. The anonymous vial ID and sample ID are alphanumeric strings or integers. An anonymous vial ID protects the privacy of an individual by not comprising any information that identifies the individual (e.g., the individual's name, initials, or birthdate).

In step 112, the processor receives a genotyping test to be performed. In certain embodiments, the genotyping test is a one or more tests related to a personal genetic profile product. In step 114, the processor presents via the GUI a list of anonymous vial IDs that have genotyping tests yet to be performed. The list may be presented in reverse chronological order based on when the biological sample was received (e.g., when the biological sample was scanned). In step 116, a genotyping plate to which to assign biological material from a vial corresponding to the anonymous vial ID is determined based on a genotyping test to be performed for the individual corresponding to the anonymous vial ID. The genotyping plate may be determined automatically, by the processor, or by a user. In certain embodiments, a genotyping plate is determined based on the number of available (e.g., unassigned) wells in each of a set of genotyping plates. In certain embodiments, a genotyping plate is determined based on the genotyping test to be performed. For example, a particular genotyping test may require a certain number of genes and/or SNPs to be measured, thus requiring that number of wells in a genotyping plate. A genotyping plate may have some wells already filled with biological material corresponding to individual(s) that have ordered that particular genotyping test. If the number of empty wells in the genotyping plate is greater than the certain number of genes and/or SNPs to be measured, that genotyping plate may be determined in step 116. In step 118, a genotyping plate ID is received by the processor. The user may enter a genotyping plate ID that corresponds to the genotyping plate into a graphical control element of the GUI or the genotyping plate ID may be automatically received by the processor once the processor has determined the genotyping plate in step 116.

In step 120, the processor presents a GUI comprising a list of unanalyzed genotyping plates (e.g., as identified by their genotyping plate IDs). The list may comprise a listing of a genotyping plate ID and an identifier of the genotyping test to be performed for that genotyping plate ID for each of a number of unanalyzed genotyping plates. Additionally, the GUI may comprise a graphical control element for each of the genotyping plates in the list for selection that that genotyping plate has been analyzed. In certain embodiments, the list is presented in a reverse chronological order based on when the biological material was deposited into well(s) of the genotyping plate. In step 122, the processor receives, via the GUI, selection that one or more of the genotyping plates in the list has been analyzed. In step 124, the analyzed plate is removed from the list. In this way, at the end of exemplary method 100, genotyping testing workflow has been tracked and recorded as they have been performed in an efficient and anonymized manner. Progress in processing samples and performing testing can easily be checked using the GUI. In certain embodiments, correspondence (e.g., emails) are sent to individuals at various stages (e.g., as certain actions are taken in the GUI) in order to keep the individuals apprised of progress in processing their samples and genotyping tests.

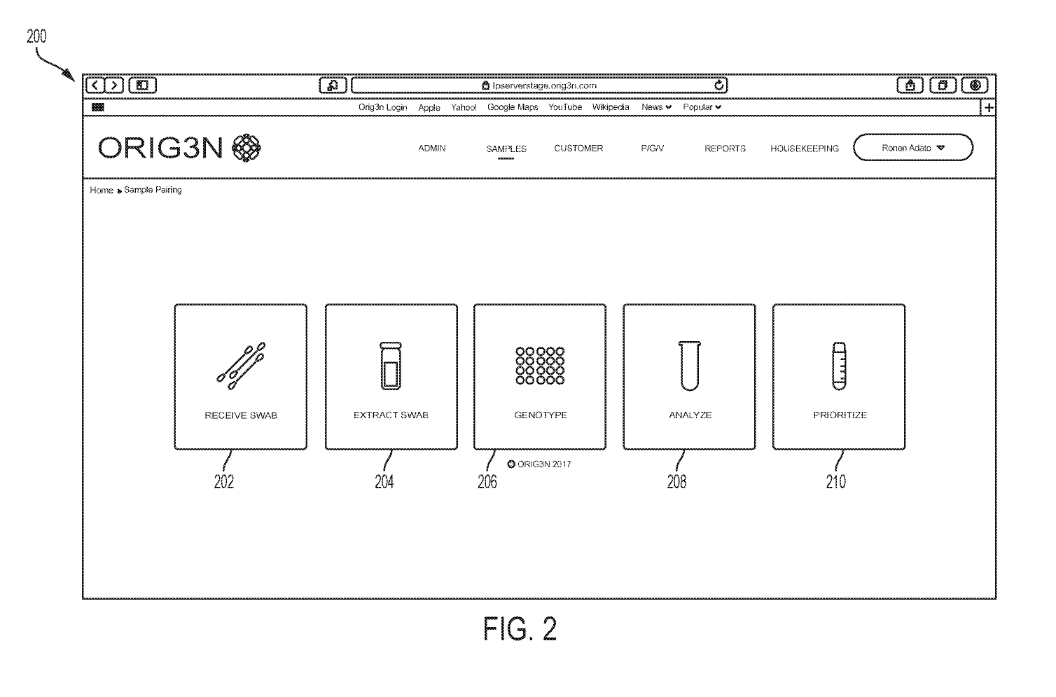

FIG. 2 is a screenshot of exemplary graphical user interface 200. Graphical control element 202 is selected to record a new biological sample received from an individual by a user. In reference to FIG. 2, a biological sample is a cheek swab. Graphical control element 204 is selected to assign biological samples to wells in a well plate in order to extract biological material from the biological sample. Graphical control element 206 is selected to assign biological material to a genotyping plate to perform a genotyping test on the biological material that has been ordered for the individual. Graphical control element 208 is selected to indicate which genotyping plates have been used to perform genotyping tests. Graphical control element 210 is selected to prioritize certain genotyping tests over other tests. For example, in the event certain genotyping data is needed before other genotyping data.

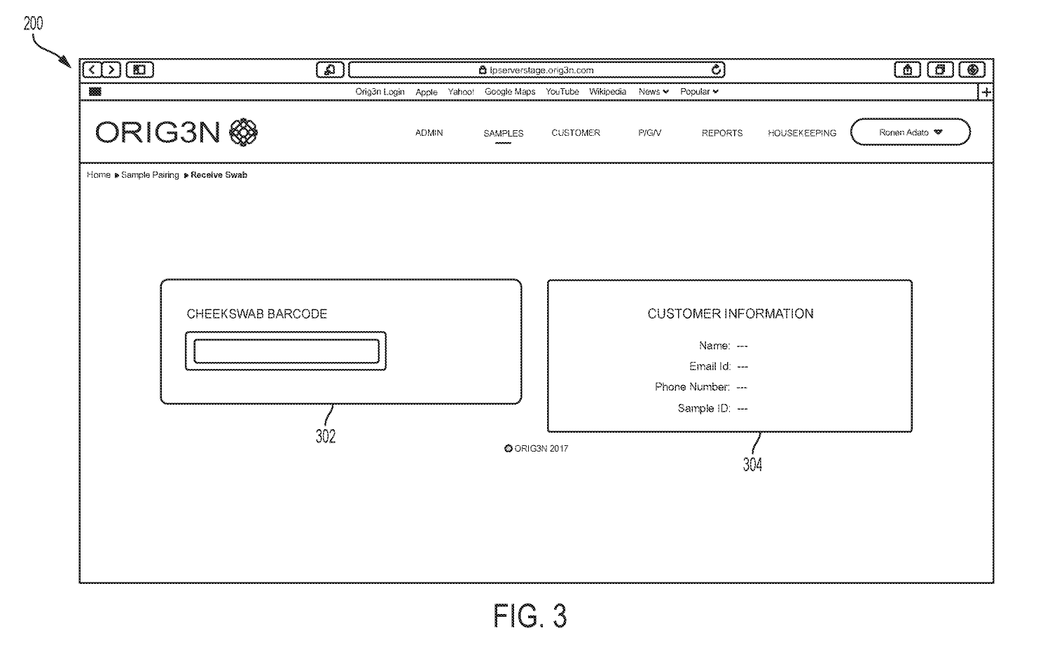

FIG. 3 is a screenshot of exemplary graphical user interface 200 when graphical control element 202 has been selected. Graphical control element 302 provides the user an input for entering a sample ID for a newly received sample. Graphical control element 302 is used, in particular, to enter a barcode affixed to a vial that contains a cheek swab for the individual. Graphical control element 302 may be automatically filled as a result of scanning the barcode with a barcode reader. Graphical control elements 304 are used to enter metadata associated with the biological sample that identifies the individual from whom the biological sample is derived. In certain embodiments, graphical control elements for entering metadata are autofilled based on a previous profile registration performed by the individual. Missing information from the metadata fields may be input by the user.

In certain embodiments, one or more graphical control elements of graphical control elements 304 provide for user entry of genotyping tests to be performed for an individual whose biological sample is being recorded. For example, a researcher may enter information about which tests are to be performed on a specimen as part of a larger experiment. As another example, a doctor or a laboratory technician at hospital may enter which genotyping-based diagnostic tests are to be performed. As another example, a laboratory technician may enter which personal genetic profile products were ordered by an individual.

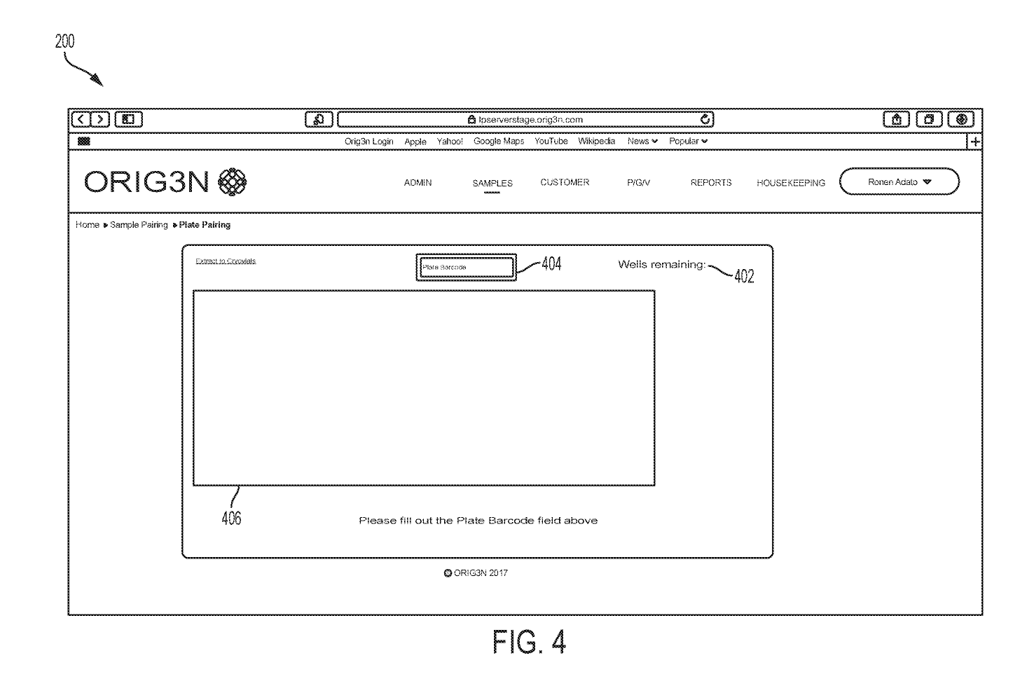

FIG. 4 is a screenshot of exemplary graphical user interface 200 when assigning biological samples to empty wells in a well plate (e.g., a 96-well plate) (i.e., when graphical control element 204 is selected). Graphical control element 404 allows a plate ID to be entered for the well plate being filled. Graphical control element 404 may be automatically filled by scanning a code on the plate (e.g., a barcode, a QR code, or a label). Indicator 402 shows the number of empty wells remaining in the current well plate. Subinterface 406 shows the status of the current plate being filled. In this screenshot, subinterface 406 is blank because a plate ID has not been entered yet.

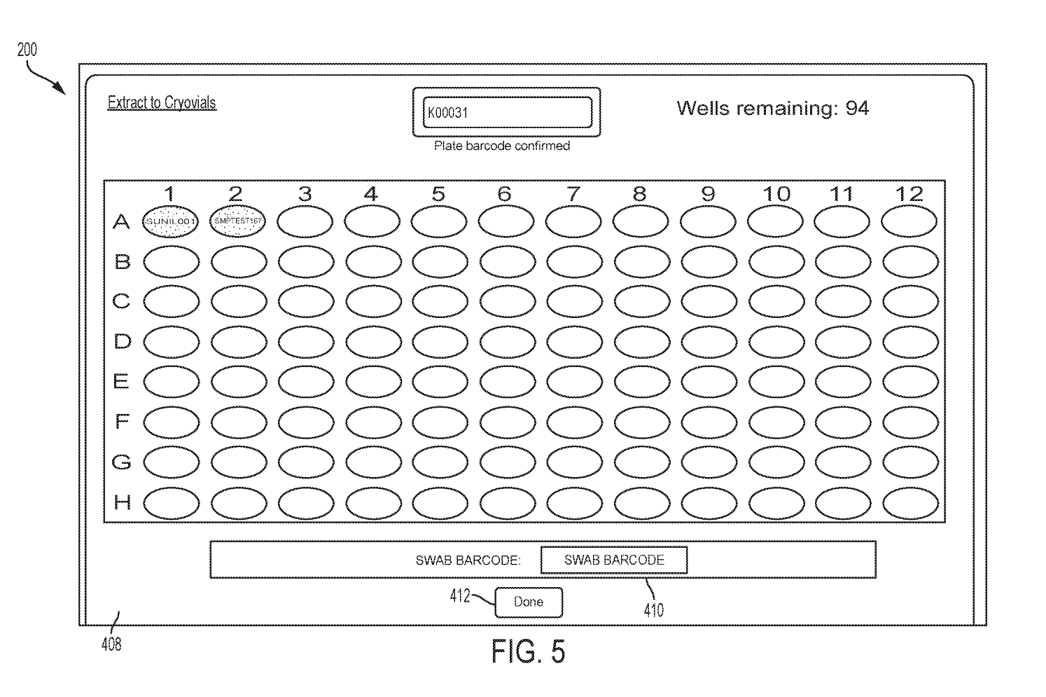

FIG. 5 is a screenshot of subinterface 406 after a plate ID has been entered. There are 94 empty wells remaining, the plate ID is K00031. Indicator 408 shows a graphical array of the well plate indicating which wells are full and which are empty. Graphical control element 410 provides for user entry of a sample ID (e.g., by scanning a barcode) for the next sample to be assigned to the well plate. When a user is finished entering sample IDs, graphical control element 412 may be selected.

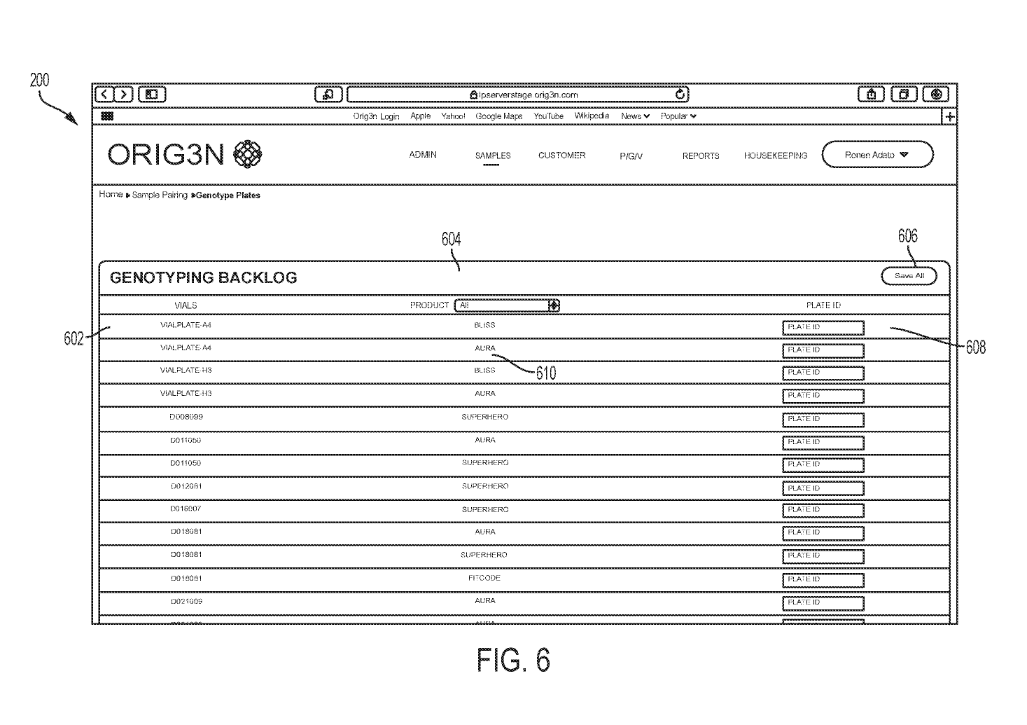

FIG. 6 is a screenshot of exemplary graphical user interface 200 when graphical control element 206 is selected. List of anonymous vial IDs 602 determined for each sample recorded is presented in reverse chronological order based on when the well plate for each anonymous vial ID was processed to extract biological material (stored in anonymous vials) from biological samples assigned thereto. List of genotyping tests 610 shows the corresponding genotyping tests ordered by and/or for the individuals associated with the anonymous vial IDs in list 602. Graphical control element 604 provides for user selection of a particular genotyping test to filter the lists based on a genotyping list of interest. List of graphical control elements 608 provide for user entry or editing of genotyping plate IDs corresponding to genotyping plates determined for biological material corresponding to the anonymous plate IDs in list 602. Graphical control element 606 may be selected to save all user entries and/or processor determination of genotyping plates (e.g., all genotyping plate IDs).

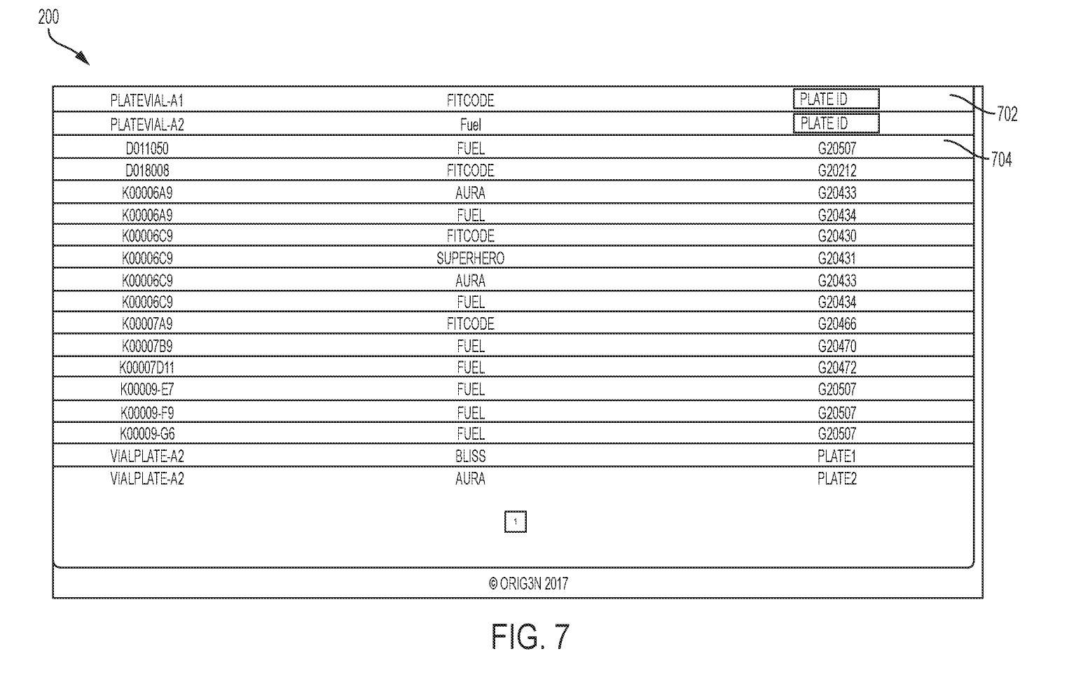

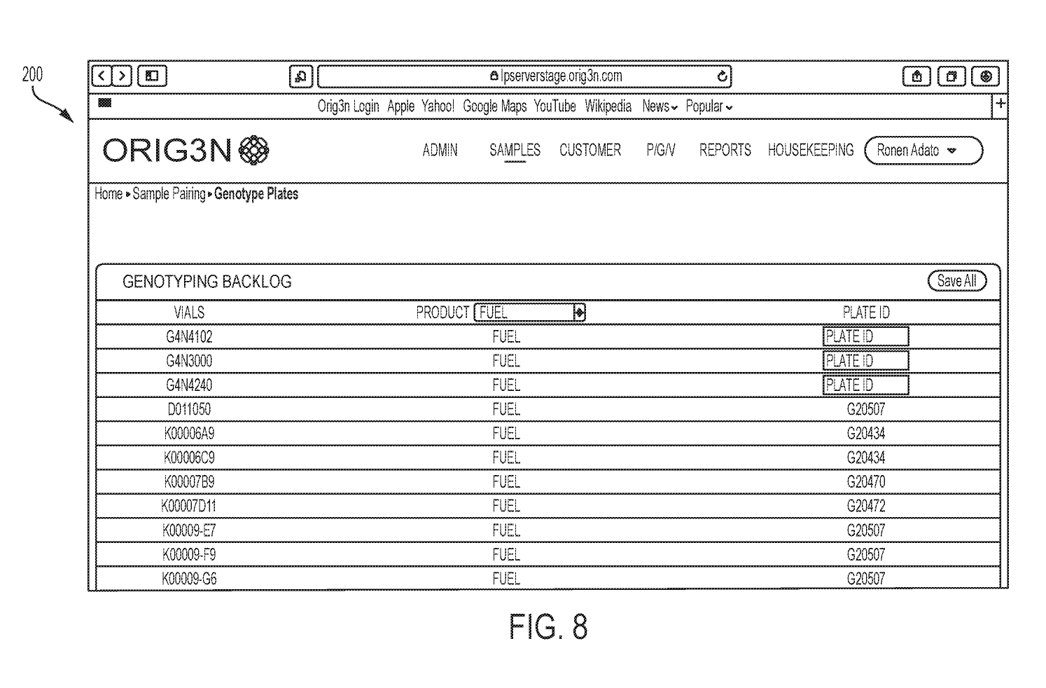

FIG. 7 is a screenshot of an alternative view of exemplary graphical user interface 200 when graphical control element 206 is selected. Line 702 shows anonymous vial ID “PLATVIAL-A1” with ordered test “FITCODE™” (a personal genetic profile product) for which a genotyping plate ID has not yet been entered. Line 704 shows anonymous vial ID “D011050” with ordered test “FUEL™” and genotyping plate ID “G20507” indicating that a genotyping plate has already been determined. FIG. 8 is a screenshot of an alternative view of exemplary graphical user interface 200 when graphical control element 206 is selected, wherein the lists have been filtered to only show those entries where the “FUEL™” (a test corresponding to a personal genetic profile product) genotyping test has been ordered. Genotyping plates have been determined for some anonymous vial IDs, but not others.

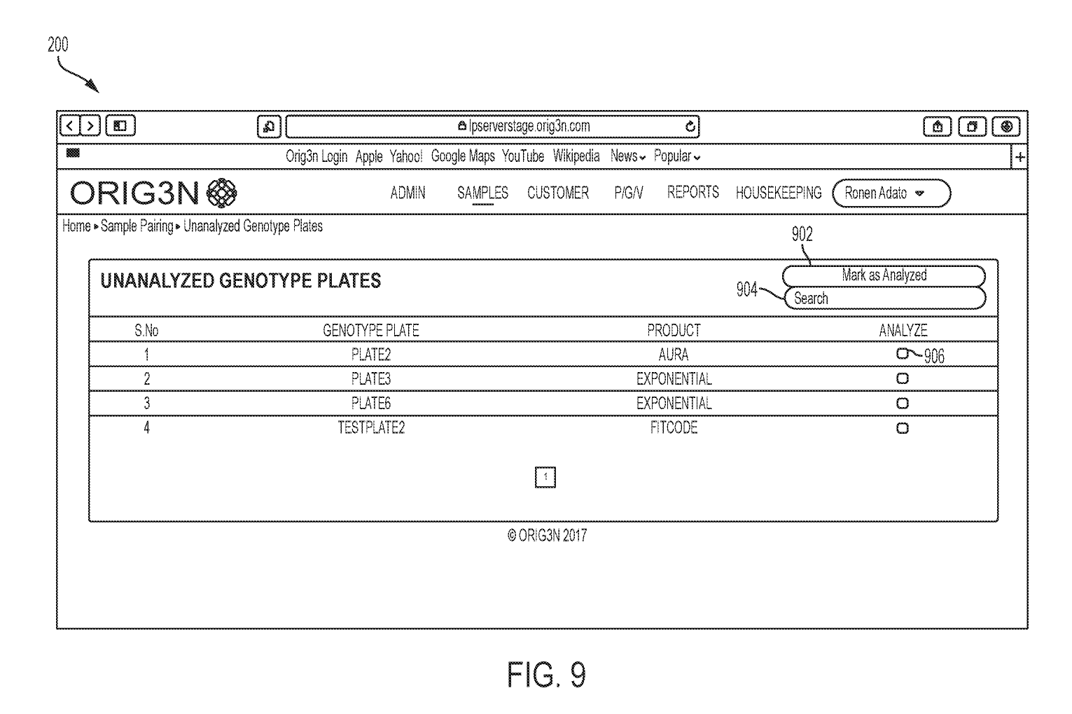

FIG. 9 is a screenshot of exemplary graphical user interface 200 when graphical control element 208 is selected. Four genotyping plates are listed (e.g., by their genotyping plate IDs) as unanalyzed in the screenshot. Graphical control element 906 is a check box that provides for user entry that the first genotyping plate has been analyzed. Each genotyping plate in the list has its own graphical control element to indicate that it has been analyzed. Graphical control element 902 may be selected to process that all genotyping plates with selected check boxes have been analyzed and remove the analyzed plates from the list of unanalyzed genotyping plates. A user may determine that a plate has been analyzed based on, for example, whether the genotyping test for the plate has been performed and/or whether data resulting from the test are of sufficient quality. Graphical control element 904 may be used to search for particular genotyping plates based on their genotyping plate IDs to determine whether they have been analyzed or not, for example, in the event that many plates are contemporaneously unanalyzed.

### Computer System and Network Architecture

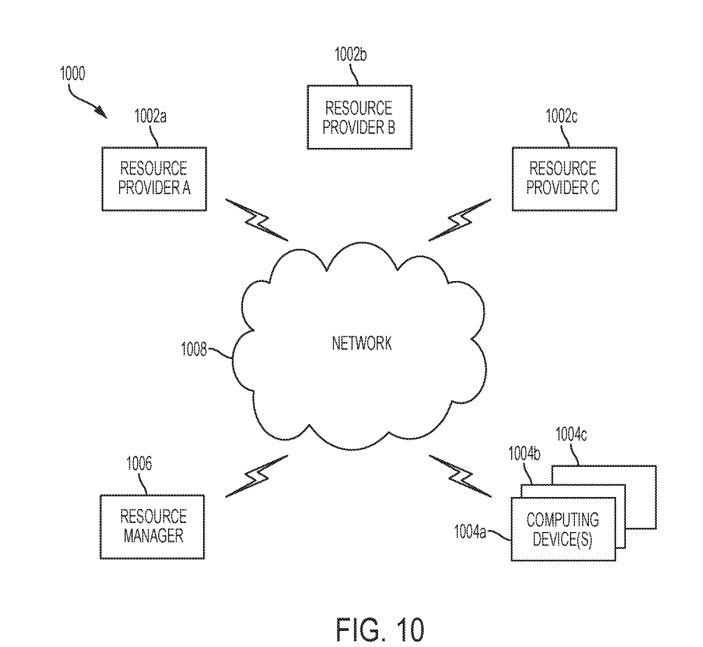

FIG. 10 shows an illustrative network environment 1000 for use in the methods and systems described herein. In brief overview, referring now to FIG. 10, a block diagram of an exemplary cloud computing environment 1000 is shown and described. The cloud computing environment 1000 may include one or more resource providers 1002a, 1002b, 1002c (collectively, 1002). Each resource provider 1002 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 1002 may be connected to any other resource provider 1002 in the cloud computing environment 1000. In some implementations, the resource providers 1002 may be connected over a computer network 1008. Each resource provider 1002 may be connected to one or more computing device 1004a, 1004b, 1004c (collectively, 1004), over the computer network 1008.

The cloud computing environment 1000 may include a resource manager 1006. The resource manager 1006 may be connected to the resource providers 1002 and the computing devices 1004 over the computer network 1008. In some implementations, the resource manager 1006 may facilitate the provision of computing resources by one or more resource providers 1002 to one or more computing devices 1004. The resource manager 1006 may receive a request for a computing resource from a particular computing device 1004. The resource manager 1006 may identify one or more resource providers 1002 capable of providing the computing resource requested by the computing device 1004. The resource manager 1006 may select a resource provider 1002 to provide the computing resource. The resource manager 1006 may facilitate a connection between the resource provider 1002 and a particular computing device 1004. In some implementations, the resource manager 1006 may establish a connection between a particular resource provider 1002 and a particular computing device 1004. In some implementations, the resource manager 1006 may redirect a particular computing device 1004 to a particular resource provider 1002 with the requested computing resource.

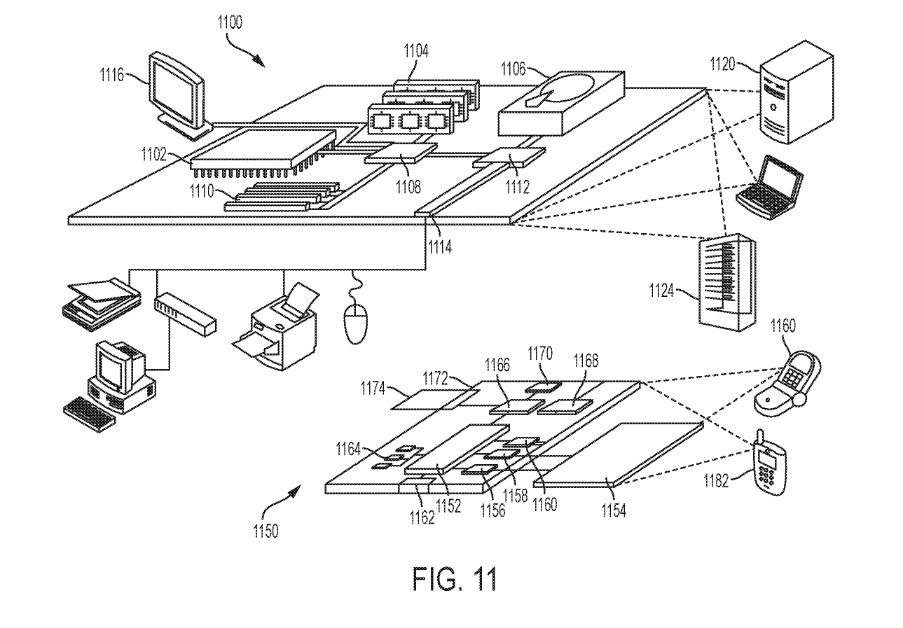

FIG. 11 shows an example of a computing device 1100 and a mobile computing device 1150 that can be used in the methods and systems described in this disclosure. The computing device 1100 is intended to represent various forms of digital computers, such as laptops, desktops, workstations, personal digital assistants, servers, blade servers, mainframes, and other appropriate computers. The mobile computing device 1150 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 1100 includes a processor 1102, a memory 1104, a storage device 1106, a high-speed interface 1108 connecting to the memory 1104 and multiple high-speed expansion ports 1110, and a low-speed interface 1112 connecting to a low-speed expansion port 1114 and the storage device 1106. Each of the processor 1102, the memory 1104, the storage device 1106, the high-speed interface 1108, the high-speed expansion ports 1110, and the low-speed interface 1112, are interconnected using various busses, and may be mounted on a common motherboard or in other manners as appropriate. The processor 1102 can process instructions for execution within the computing device 1100, including instructions stored in the memory 1104 or on the storage device 1106 to display graphical information for a GUI on an external input/output device, such as a display 1116 coupled to the high-speed interface 1108. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system). Thus, as the term is used herein, where a plurality of functions are described as being performed by “a processor”, this encompasses embodiments wherein the plurality of functions are performed by any number of processors (one or more) of any number of computing devices (one or more). Furthermore, where a function is described as being performed by “a processor”, this encompasses embodiments wherein the function is performed by any number of processors (one or more) of any number of computing devices (one or more) (e.g., in a distributed computing system).

The memory 1104 stores information within the computing device 1100. In some implementations, the memory 1104 is a volatile memory unit or units. In some implementations, the memory 1104 is a non-volatile memory unit or units. The memory 1104 may also be another form of computer-readable medium, such as a magnetic or optical disk.

The storage device 1106 is capable of providing mass storage for the computing device 1100. In some implementations, the storage device 1106 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 1102), perform one or more methods, such as those described above. The instructions can also be stored by one or more storage devices such as computer- or machine-readable mediums (for example, the memory 1104, the storage device 1106, or memory on the processor 1102).

The high-speed interface 1108 manages bandwidth-intensive operations for the computing device 1100, while the low-speed interface 1112 manages lower bandwidth-intensive operations. Such allocation of functions is an example only. In some implementations, the high-speed interface 1108 is coupled to the memory 1104, the display 1116 (e.g., through a graphics processor or accelerator), and to the high-speed expansion ports 1110, which may accept various expansion cards (not shown). In the implementation, the low-speed interface 1112 is coupled to the storage device 1106 and the low-speed expansion port 1114. The low-speed expansion port 1114, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 1100 may be implemented in a number of different forms, as shown in the figure. For example, it may be implemented as a standard server 1120, or multiple times in a group of such servers. In addition, it may be implemented in a personal computer such as a laptop computer 1122. It may also be implemented as part of a rack server system 1124. Alternatively, components from the computing device 1100 may be combined with other components in a mobile device (not shown), such as a mobile computing device 1150. Each of such devices may contain one or more of the computing device 1100 and the mobile computing device 1150, and an entire system may be made up of multiple computing devices communicating with each other.

The mobile computing device 1150 includes a processor 1152, a memory 1164, an input/output device such as a display 1154, a communication interface 1166, and a transceiver 1168, among other components. The mobile computing device 1150 may also be provided with a storage device, such as a micro-drive or other device, to provide additional storage. Each of the processor 1152, the memory 1164, the display 1154, the communication interface 1166, and the transceiver 1168, are interconnected using various buses, and several of the components may be mounted on a common motherboard or in other manners as appropriate.

The processor 1152 can execute instructions within the mobile computing device 1150, including instructions stored in the memory 1164. The processor 1152 may be implemented as a chipset of chips that include separate and multiple analog and digital processors. The processor 1152 may provide, for example, for coordination of the other components of the mobile computing device 1150, such as control of user interfaces, applications run by the mobile computing device 1150, and wireless communication by the mobile computing device 1150.

The processor 1152 may communicate with a user through a control interface 1158 and a display interface 1156 coupled to the display 1154. The display 1154 may be, for example, a TFT (Thin-Film-Transistor Liquid Crystal Display) display or an OLED (Organic Light Emitting Diode) display, or other appropriate display technology. The display interface 1156 may comprise appropriate circuitry for driving the display 1154 to present graphical and other information to a user. The control interface 1158 may receive commands from a user and convert them for submission to the processor 1152. In addition, an external interface 1162 may provide communication with the processor 1152, so as to enable near area communication of the mobile computing device 1150 with other devices. The external interface 1162 may provide, for example, for wired communication in some implementations, or for wireless communication in other implementations, and multiple interfaces may also be used.

The memory 1164 stores information within the mobile computing device 1150. The memory 1164 can be implemented as one or more of a computer-readable medium or media, a volatile memory unit or units, or a non-volatile memory unit or units. An expansion memory 1174 may also be provided and connected to the mobile computing device 1150 through an expansion interface 1172, which may include, for example, a SIMM (Single In Line Memory Module) card interface. The expansion memory 1174 may provide extra storage space for the mobile computing device 1150, or may also store applications or other information for the mobile computing device 1150. Specifically, the expansion memory 1174 may include instructions to carry out or supplement the processes described above, and may include secure information also. Thus, for example, the expansion memory 1174 may be provided as a security module for the mobile computing device 1150, and may be programmed with instructions that permit secure use of the mobile computing device 1150. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier and, when executed by one or more processing devices (for example, processor 1152), perform one or more methods, such as those described above. The instructions can also be stored by one or more storage devices, such as one or more computer- or machine-readable mediums (for example, the memory 1164, the expansion memory 1174, or memory on the processor 1152). In some implementations, the instructions can be received in a propagated signal, for example, over the transceiver 1168 or the external interface 1162.

The mobile computing device 1150 may communicate wirelessly through the communication interface 1166, which may include digital signal processing circuitry where necessary. The communication interface 1166 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 1168 using a radio-frequency. In addition, short-range communication may occur, such as using a Bluetooth®, Wi-Fi™, or other such transceiver (not shown). In addition, a GPS (Global Positioning System) receiver module 1170 may provide additional navigation- and location-related wireless data to the mobile computing device 1150, which may be used as appropriate by applications running on the mobile computing device 1150.

The mobile computing device 1150 may also communicate audibly using an audio codec 1160, which may receive spoken information from a user and convert it to usable digital information. The audio codec 1160 may likewise generate audible sound for a user, such as through a speaker, e.g., in a handset of the mobile computing device 1150. Such sound may include sound from voice telephone calls, may include recorded sound (e.g., voice messages, music files, etc.) and may also include sound generated by applications operating on the mobile computing device 1150.

The mobile computing device 1150 may be implemented in a number of different forms, as shown in the figure. For example, it may be implemented as a cellular telephone 1180. It may also be implemented as part of a smart-phone 1182, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

### Storage and Presentation of Personal Genetic Profile Assessments

In certain embodiments, the systems and methods described herein facilitate processing biological samples to perform genotyping tests corresponding to assessments that an individual may have performed in order to gain insight into the different ways that their genetic makeup influences their health, physical characteristics, and behavior. An individual may, for example, purchase an particular assessment to have a particular set of SNPs measured for them via a particular genotyping test, and the resultant genotyping data presented to them via a personal genetic profile assessment. An individual may purchase one or more assessments and have their results aggregated into a personal genetic profile assessment for them.

In certain embodiments, as described herein, a flexible and hierarchical data structure framework is used as a flexible template that facilitates both the rapid creation of individual personal genetic profile assessments from genotyping measurements taken from a plurality of individuals, as well as the presentation of an individual's personal genetic profile assessment. As described herein, the data structure framework allows for the genotyping data obtained via a various genotyping tests to be organized in an informative and intuitive fashion for storage and presentation to the individual. The flexible and hierarchical data structure framework is also described in detail in U.S. Provisional Application No. 62/436,947, filed Dec. 20, 2016, U.S. Non-Provisional application Ser. No. 15/445,752, filed Feb. 28, 2017, and U.S. Provisional Application No. 62/485,322, filed Apr. 13, 2017, the contents of each of which are hereby incorporated by reference herein in their entirety

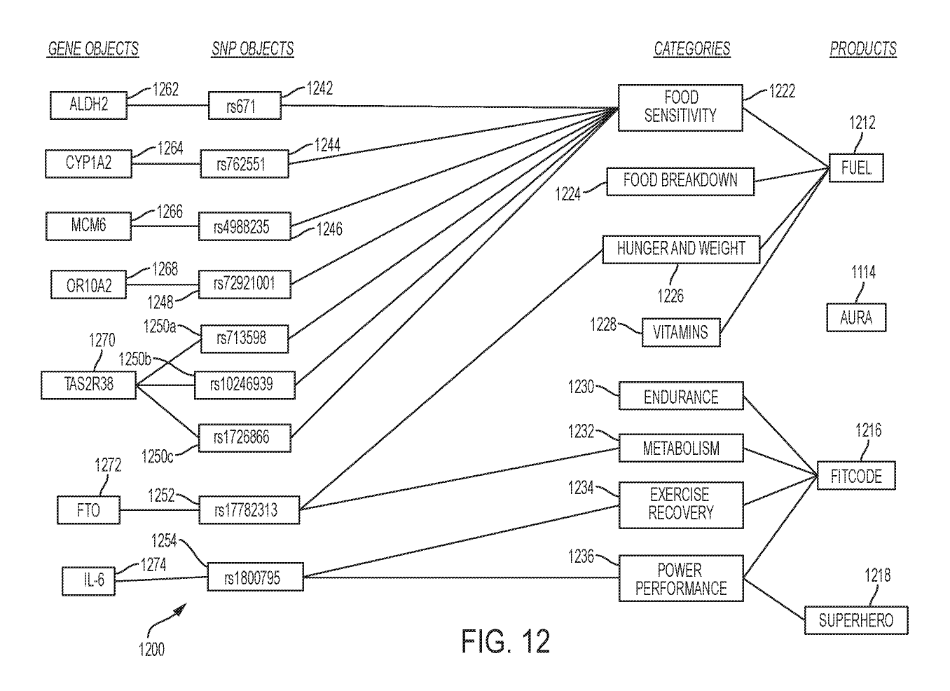

In particular, turning to FIG. 12, the framework provides for storing relationships (e.g. associations) between particular SNPs, biological traits and characteristics, and general classes of such traits and characteristics, based on the specific traits that each particular SNP influences.

In certain embodiments, a first (e.g., top level) class of data structures, referred to herein as products, are used to represent different general classes of health-related traits and characteristics. In certain embodiments, a product data structure corresponds to a particular assessment ordered (e.g., purchased by the individual), in which unique versions of genes and/or SNPs that an individual has that influence the particular general class of health-related traits and characteristics that the corresponding product represents are identified (e.g., via genotyping measurements). As described herein, a particular product can be associated with a specific set of SNP objects that represent a specific set of SNPs that relate to (e.g., influence). In this manner, a particular product may correspond to a particular genotyping test in which the specific set of SNPs (e.g., represented by SNP objects associated with the particular product) are measured to generate genotyping data used for creation of personal genetic profile assessments.

In certain embodiments, each product has a name (e.g. a product data structure comprises a name (e.g. text data representing the name)) that provides a convenient, and memorable way to refer to the product. For example, a particular product 1212 (e.g. named “FUEL™”) is used to represent a class of traits corresponding to the way in which an individual's body processes different foods and nutrients. Another product 1214 (e.g. named “AURA™”) is used to represent a class of traits corresponding to skin health. Another product 1216 (e.g. named “FITCODE™”) is used to represent a class of traits corresponding to physical fitness. Another product 1218 (e.g. named “SUPERHERO™”) is used to represent a class of traits corresponding to physical and intellectual performance. In certain embodiments, a name of a product is the same as the name under which a particular assessment is offered for sale. For example, assessments FUEL™, FITCODE™, AURA™ and SUPERHERO™ are offered for sale by Orgi3n, Inc. of Boston Mass.

In certain embodiments, each product is in turn associated with one or more of a second class of data structures, referred to as categories. In certain embodiments, each category corresponds to a particular health-related trait or characteristic (e.g. food sensitivity, food breakdown, hunger and weight, vitamins, skin uv sensitivity, endurance, metabolism, joint health, muscle strength, intelligence). In certain embodiments, the categories with which a particular product is associated each correspond to different health-related traits or characteristics that are related to the general class of health-related traits or characteristics to which the particular product corresponds (e.g. the general class of health-related traits or characteristics that the product represents). As with products, in certain embodiments, each category has a name (e.g. a category data structure comprises a name (e.g. text data representing the name)) that provides a convenient, and memorable way to refer to the category.

In turn, each category is associated with one or more SNP objects, each SNP object corresponding to a specific SNP. Each SNP object associated with a particular category corresponds to a specific SNP that influences a specific health related trait that relates to the trait or characteristic to which the particular category corresponds. Each SNP object may identify the specific SNP to which it corresponds via a SNP reference that the SNP object comprises. The SNP reference may be an alphanumeric code such as an accepted name of the SNP or other identifying mark or label capable of being stored electronically. The SNP reference may be an alphanumeric code such as a National Center for Biotechnology Information (NCBI) database reference number.

For example, the schematic of FIG. 12 shows an example of series of products, categories, and SNP objects that are associated with each other. Associated gene objects, to be described in the following, are also shown. The different products and categories are identified by their particular names, and the SNP objects each are identified by a respective SNP reference each comprises. In the example of FIG. 12, the SNP references are NCBI database reference numbers.

The “FUEL™” product 1212 is associated with categories such as “Food Sensitivity” 1222, “Food Breakdown” 1224, “Hunger and Weight” 1226, and “Vitamins” 1228. Several SNP objects corresponding to specific SNPs that influence characteristics related to an individual's sensitivity to different types of foods, and, accordingly, are associated with the “Food Sensitivity” category 1222 are shown. In FIG. 12, the lines connecting the SNP objects to different categories indicate the association of each particular SNP object with one or more different categories. The associations may be direct associations or indirect associations (i.e., through mutual association with an intermediate data structure not shown).

For example, SNP object 1232 corresponds to the rs671 SNP, which influences the manner in which an individual processes alcohol. In particular, depending on the particular variant of the rs671 SNP that an individual has, the individual may process alcohol normally, or be impaired in their ability to process alcohol, and likely suffer from adverse effects resulting from alcohol consumption, such as flushing, headaches, fatigue, and sickness. Accordingly, providing individuals with knowledge of the particular variant of the rs671 SNP they possess may allow them to modify their behavior accordingly, for example, by being mindful of the amounts of alcohol that they consume (e.g. on a regular basis, e.g. in social settings).

Other SNP objects corresponding to SNPs that influence food sensitivity related characteristics, and, accordingly, are associated with the “Food Sensitivity” category 222 are shown. For example, SNP object 1244 corresponds to the rs762551 SNP that influences caffeine metabolism, SNP object 1246 corresponds to the rs4988235 SNP that influences lactose intolerance, and SNP object 1248 corresponds to the rs72921001 SNP that influences an aversion to the herb cilantro (e.g. depending on the particular variant of this SNP that an individual has, they may either perceive cilantro as pleasant tasting or bitter and soap-like in taste).

In certain examples, multiple SNPs are associated with a particular characteristic and, accordingly, the SNP objects to which they correspond may be grouped together. For example, three SNPS—rs713598 (corresponding to SNP object 1250a), rs10246939 (corresponding to SNP object 1250b), and rs1726866 (corresponding to SNP object 1250c),—influence the sensitivity of individuals to bitter tasting foods (e.g. cabbage, broccoli, cauliflower, kale, brussel sprouts, and collard greens), and, accordingly, their enjoyment of or aversion to such foods.

SNPs correspond to specific locations within or nearby (e.g., a SNP may occur in a promotor region that influences transcription of a particular gene, e.g., a SNP may occur within 5 kb upstream or downstream of a particular gene, e.g., a SNP may occur within 100 kb upstream or downstream of a particular gene, e.g., a SNP may occur within 500 kb upstream or downstream of a particular gene, e.g., a SNP may occur within 1 Mb upstream or downstream of a particular gene) genes in an individual's genetic material. Accordingly, in certain embodiments, as shown in FIG. 12, each SNP object is associated with a gene object that corresponds to the particular gene within or nearby to which the SNP to which the SNP object corresponds is present. For example, the rs671 SNP corresponds to a location within the ALDH2 gene; the rs762551 SNP corresponds to a location within the CYP1A2 gene, the rs4988235 SNP occurs within the MCM6 gene, and the rs72921001 SNP occurs within the OR10A2 gene. Accordingly, SNP object 1242 (corresponding to the rs671 SNP) is associated with gene object 1262 (corresponding to the ALDH2 gene). Similarly, SNP object 1244 (corresponding to the rs762551 SNP) is associated with gene object 1262 (corresponding to the CYP1A2 gene), SNP object 1246 (corresponding to the rs4988235 SNP) is associated with gene object 1266 (corresponding to the MCM6 gene) and SNP object 1248 (corresponding to the rs72921001 SNP) is associated with gene object 1268 (corresponding to the OR10A2 gene).

Other SNPs objects correspond to SNPs that are nearby particular genes of interest and thereby influence characteristics associated with expression of the gene. For example, rs12696304 is a SNP that lies 1.5 kb downstream from the TERC gene, and influences biological aging associated with the TERC gene. Accordingly, in one example, a SNP object corresponding to the rs12696304 SNP is associated a gene object corresponding to the TERC gene.

In certain embodiments, multiple SNPs of interest occur within a single gene. For example, the three SNPs related to bitter taste—rs713598, rs10246939, and rs1726866—occur within the TAS2R38 gene. Accordingly, SNP objects 1250a, 1250b, and 1250c, which correspond to the rs713598, rs10246939, and rs1726866 SNPs, respectively, are all associated with a gene object 1270 corresponding to the TAS2R38 gene.

In certain embodiments, different products correspond to different general classes of health-related traits and characteristics. For example, products may be based on particular organs (e.g. product 1214, named “AURA™”, is related to skin health), or particular habits, activities, or bodily functions. For example, food related biological characteristics and traits may be covered by a single products or a plurality of products. A single product or a plurality of products may be based on learning and brain function characteristics and traits. A single product or a plurality of products may be based on physical fitness (e.g., cardiovascular strength, agility, flexibility, muscular strength).

For example, as shown in FIG. 12, another product 1216 (e.g. named “FITCODE™”), relates to a general class of physical fitness related traits, and, accordingly, comprises categories associated with endurance 1230 (“Endurance”), metabolism 1232 (“Metabolism”), the ability of an individual to recover effectively following exercises 1234 (“Exercise Recovery”), and cardiovascular fitness and skeletal muscle makeup 1236 (“Power Performance”).

In certain embodiments, a particular SNP object is associated with two or more categories. For example, the rs17782313 SNP, occurring in the FTO gene, influences an individual's appetite. Accordingly, as shown in FIG. 12, the SNP object 1252 corresponding to the rs17782313 SNP is associated with both the “Hunger and Weight” category 1226 of the “FUEL™” product, and the “Metabolism” category 1232 of the “FITCODE™” product. SNP object 1252 is also associated with gene object 1272, reflecting the fact that the rs17782313 SNP occurs in the FTO gene. In certain embodiments, as with the rs17782313 SNP object, each of a first category and a second category with which a particular SNP object is associated are associated with a different product. In certain embodiments, a particular SNP object is associated with a first category and a second category, and both the first category and the second category are associated with the same product.

For example, the SNP object 1254 corresponding to the rs1800795 SNP of the IL-6 gene (accordingly, SNP object 1254 is associated with gene object 1274, which corresponds to the IL-6 gene) is associated with the “Exercise Recovery” category 1234 and the “Power Performance” category 1236, both of which are associated with the “FITCODE™” product 1216. In addition, in certain embodiments, a category is associated with two or more products. For example, the “Power Performance” category 1236 is associated with the “FITCODE™” product 1216, as well as the “SUPERHERO™” product 1218, which provides an assessment of a general class of traits related to physical and intellectual performance.

In certain embodiments the hierarchical organization of product, category, SNP object, gene object, and variant object data structures serves as a flexible template that facilitates both the rapid creation of individual personal genetic profile assessments from genotyping measurements taken from a plurality of individuals, and the presentation of an individual's personal genetic profile assessment. In particular, an individual may purchase assessments corresponding to different products, in order to gain insight into the manner in which their personal genome influences the different general classes of health-related traits and characteristics to which each different product corresponds. Accordingly, an individual's personal genetic profile assessment corresponding to one or more products comprises, for each specific SNP associated with each category that is associated with each of the one or more products, an identification of the particular variant of the specific SNP that the individual has. Typically, the identification is obtained via one or more genotyping measurements performed on a biological sample taken from the individual (e.g. a blood sample, e.g. a cheek swab sample, e.g. a saliva sample, e.g. a hair sample, e.g. hair follicle cells).

In certain embodiments, an individual may purchase a first assessment corresponding to a first product, and provide a biological sample for genotyping. The individual's biological sample may be stored (e.g. cryogenically frozen). After a period of time, the individual may choose to purchase additional assessments corresponding to other products, and the individual's previously stored biological sample may be taken from storage for additional genotyping measurements of the additional SNPs that are associated with the new products. Moreover, in certain embodiments, additional new products may be created over time, and new assessments corresponding to new products offered to and purchased by individuals. In certain embodiments, as new information related to the influence of new and/or existing SNPs on different specific health related characteristics is elucidated, new SNP objects and gene objects may be created, and new associations between them and new or existing categories and/or products established. In certain embodiments, existing personal genetic profile assessments of individuals are automatically updated to reflect new information.

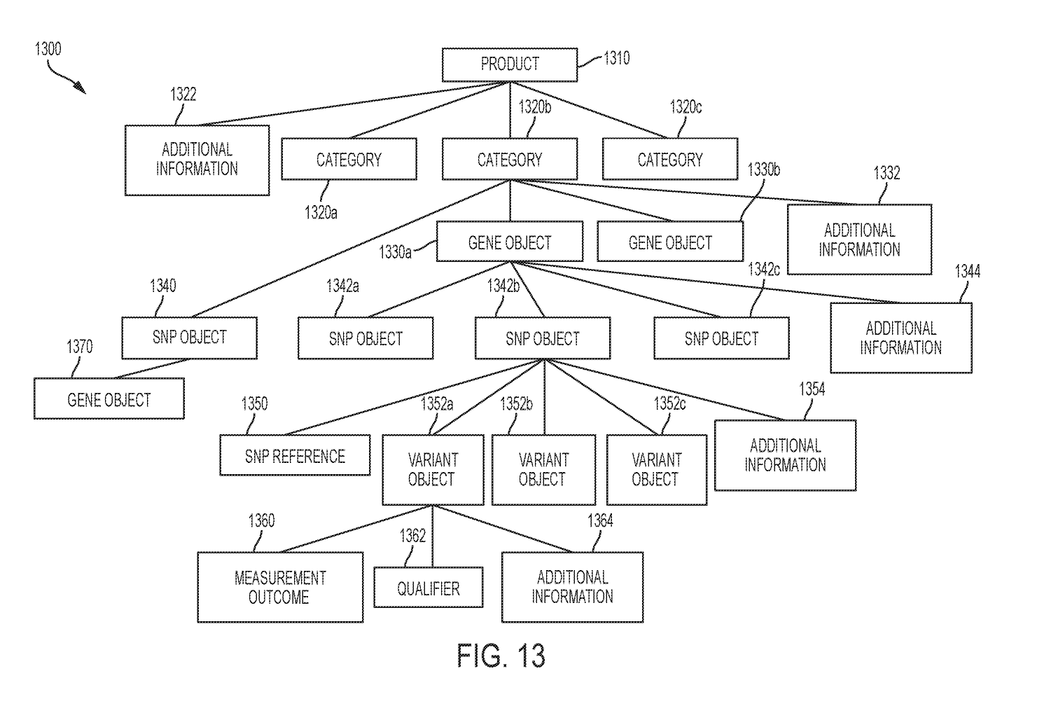

In certain embodiments, in order to facilitate the creation and presentation of individual personal genetic profile assessments (e.g. corresponding to one or more different products) based on the framework described above, the product, category, SNP object, and gene object data structures described herein are created and associated as a generic hierarchy of data structures to later be associated with the genotyping data of an individual. FIG. 13 is a block diagram of a hierarchy of data structures 1300 of an example genetic profile product. In certain embodiments, a developer creates and stores one or more generic hierarchies of data structures in accordance with FIG. 2 that define one or more products that may be purchased and/or accessed by an individual. The hierarchies of data structures are generic in that they contain no personal information for any one individual, but instead define the collection of genes, SNPs, and variants that have relevance to the biological characteristics and/or traits that are encompassed by a product.

An exemplary data structure of each type is shown to be associated with sub-data structures in FIG. 13 in order to simplify presentation of the figure. It is understood that data structures may be associated to any number of other data structures in the hierarchy if the association is consistent with the associations shown in FIG. 13. For example, category 1320b is shown to be associated with gene objects 1330a-b while category 1320c may be associated with one or more gene objects and/or SNP objects, but any such associations are not shown. In some embodiments, data structures may be created without also forming associations between other structures of relevant types. For example, unassociated or partially associated data structures may be created for planning purposes such as during product or category development (e.g., category 1320a has no associations yet because its scope has not been determined yet by the user). For example, unassociated or partially associated data structures may be created to allow genotyping data to be associated with relevant gene objects or SNP objects in order to retain the data in a ready to use format in the event that the gene objects and/or SNP objects are later associated with one or more categories.

Referring now to FIG. 13, product 1310 comprises three categories 1320a-c and additional information 1322. Additional information 1322 may be a name of the product, an icon associated with the product, and/or a description of the product. Category 1320b comprises two gene objects 1330a-b, one SNP object 1340, and additional information 1332. Additional information 1332 may comprise a name of the category, a background image associated with the category, an icon associated with the category, a category order identifier, and/or a description of the category. SNP object 1340 is associated with gene object 1370. Gene object 1330a is associated to three SNP objects 1342a-c. Categories may be associated directly to SNP objects, such as category 1320b is associated with SNP object 1340, or they may be associated indirectly such as SNP objects 1342a-c are associated to category 1320b via gene object 1330a. The ability to form associations indirectly allows all SNP objects associated with a particular gene object to be associated with a category by forming a single association in cases where all SNP objects of a particular gene are relevant to a particular category. The ability to form associations directly allows a particular SNP object to be associated with a category without also forming an association with all other SNP objects associated with the gene object associated with the particular SNP object in cases where only one or a subset of SNP objects of a particular gene object are relevant to a category.

Gene object 1330a is also associated with additional information 1344. Additional information 1344 may comprise one or more data structures comprising information such as a unique gene identifier that corresponds gene object 1330a to a specific physical gene and descriptive information about the corresponding gene. The gene identifier may be an alphanumeric code such as an accepted name of the gene or other identifying mark or label capable of being stored electronically. Additional information may be stored as a single data structure or a plurality of data structures.

SNP object 1342b is associated with SNP reference 1350, and additional information 1354. SNP reference 1350 is a unique identifier of the SNP that corresponds the SNP object to a specific physical SNP. The SNP reference may be an alphanumeric code such as an accepted name of the gene or other identifying mark or label capable of being stored electronically. The SNP reference may be an alphanumeric code such as a National Center for Biotechnology Information (NCBI) database reference number. Additional information 1354 may comprise one or more data structures with other descriptive information about the corresponding SNP.

Variants of a particular SNP can be represented within a corresponding SNP object using various combinations of data elements such as a measurement outcomes, and qualifiers. For example, a particular variant of a SNP can be identified by a measurement outcome, which is an identifier, such as an alphanumeric code, that identifies the specific alleles corresponding to the particular variant. For example, a measurement outcome such as the string “CC” identifies a first variant of the rs762551 SNP in which an individual has a cytosine (C) at the rs762551 position in each copy of their genetic material. A measurement outcome such as the string “AC” identifies a second variant of the rs762551 SNP in which an individual has a C in one copy and an adenine (A) in the other at the rs762551 position. A measurement outcome such as the string “AA” identifies a second variant of the rs762551 SNP in which an individual has an A at the rs762551 position in each copy of their genetic material. A qualifier is an identifier, such as an alphanumeric code, that identifies a classification of a variant, wherein the classification may be based on the prevalence of the variant within a population, a health-related phenotype associated with the variant, and/or other relevant classification bases. Additional information may also be included within a SNP object to describe a particular variant.

In certain embodiments, measurement outcomes and qualifiers that identify and classify, respectively the same variant are associated with each other to form a variant object associated with the SNP object. For example, variant object 1352a comprises measurement outcome 1360, qualifier 1362. Variant object 1352a is also comprises additional information 1364. Additional information 1364 comprises a description of the variant. For example, the additional information comprises a description of the specific health-related phenotype that an individual with the variant represented by variant object 1352a exhibits or an explanation of the prevalence of the variant. A SNP object may be associated with a variant object to represent each variant of the particular SNP to which it corresponds. For example, SNP object is associated with three variant objects 1352a-c.

In certain embodiments, the data structures described herein above are stored as a generic hierarchy for use in generating an individual's personal genetic profile assessment. A collection of data structures corresponding to genes, SNPs, and variants may be organized into one or more categories within a product (as visualized in FIG. 13, for example). Products can be personalized to a particular individual in order to provide them with specific information about their particular genome by populating or associating the generic product with the individual's genotyping data. In certain embodiments, a personal genetic profile assessment is used to populate an assessment graphical user interface (“assessment GUI”) through which an individual views an assessment of his/her genetic profile. In this way, the individual can view an assessment GUI that visualizes his/her personal genetic profile assessment by showing the individual the particular variants of SNPs that the individual has (e.g., organized in a hierarchy of products and categories).

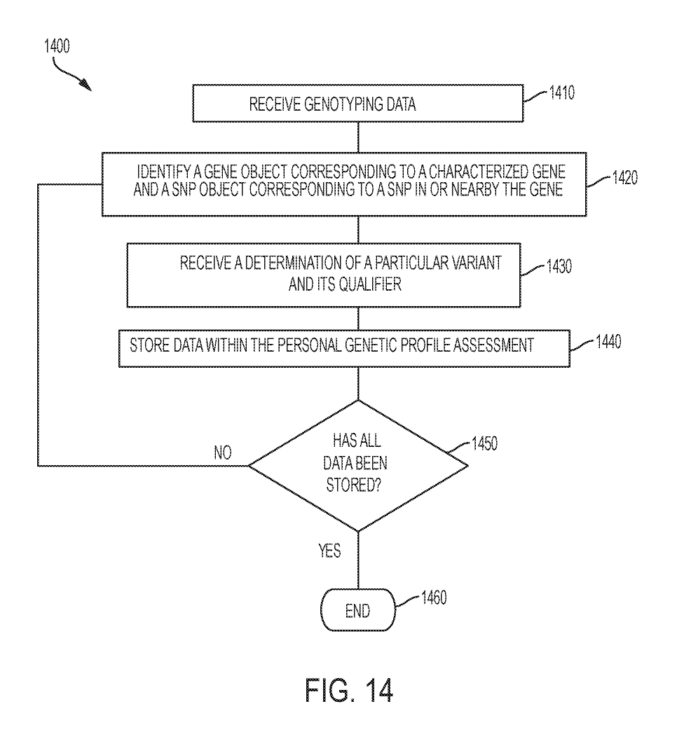

In certain embodiments, in order to populate an assessment GUI to provide to an individual, genotyping data must be added or associated to the individual's personal genetic profile assessment. FIG. 14 is a block diagram of exemplary method 1400 for adding genotyping data to an individual's personal genetic profile assessment. In step 1410, a processor of a computing device receives genotyping data. In step 1420, the processor identifies a gene object corresponding to a gene measured in the genotyping data and a SNP object corresponding to a SNP in or nearby the gene (e.g. the SNP occurring within the gene or occurring nearby the gene (e.g. within a promotor region that influences transcription of the gene, e.g. within 5 kb upstream or downstream of the gene, e.g. within 100 kb upstream or downstream of the gene, e.g. within 500 kb upstream or downstream of the gene, e.g. within 1 Mb upstream or downstream of the gene). In certain embodiments, genotyping data is stored as a table of data in a text file where each row corresponds to a unique SNP. In step 1430, a particular variant of the SNP represented by the identified SNP object and its associated qualifier are determined based on data from genotyping measurements. For example, data corresponding to the measurement outcome of a particular variant may be stored as one or more columns at the end of each row. In step 1440, the data is stored in the individual's personal genetic profile assessment. In accordance with method 1400, at step 1440, the data may be stored in a (previously generic) hierarchy of data structures or the data may be stored separately along with an association between the data and the identified gene object and SNP object. In any case, the stored data (and any generated and stored associations) define the personal genetic profile assessment for the individual. In step 1450, the processor determines if all data of the genotyping data has been stored. If all data has not been stored in the individual's personal genetic profile assessment, then the method returns to step 1420. If all data has been stored, then the method ends 1460. In some embodiments, the processor determines if unstored data exists by determining if there is a row of data in the genotyping data below the just processed row.

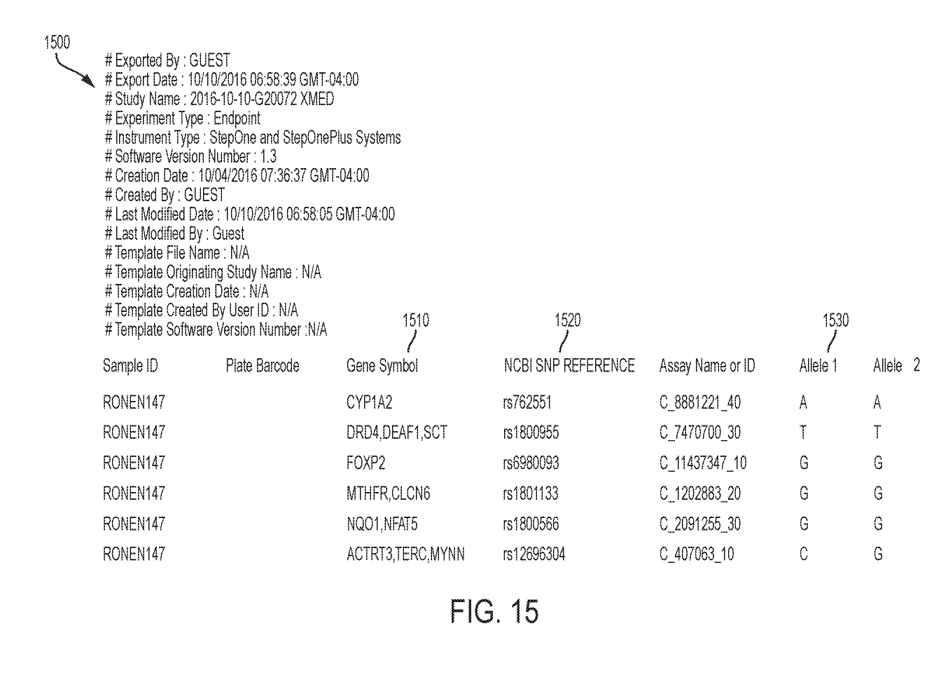

FIG. 15 shows exemplary genotyping data 1500 that may be added to an individual's personal genetic profile assessment in accordance with method 1400. Genotyping data may take the form of a text file saved by a user, wherein the text file is generated manually or as output from equipment for performing genotyping measurements (e.g. TaqMan™ SNP genotyping assays). FIG. 15 comprises 6 rows of genotyping data from a single biological sample (“RONEN147”). Each row corresponds to data for a different SNP. Each SNP of genotyping data 1500 is identified by at least a gene identifier 1510 and a SNP reference 1520. The gene identifier identifies the gene with which the SNP is associated. In certain embodiments, multiple (e.g. two or more) genes are associated with the SNP (e.g. the SNP may occur nearby two or more genes and influence phenotypes associated with each of the associated genes), and, accordingly, two or more corresponding gene identifiers are listed. Each SNP in the genotyping data has a corresponding variant identified by the allele measurements 1530. The measurements “allele 1” and “allele 2” for a given SNP may be compared with measurement outcomes associated with the variants of a SNP object corresponding to the given SNP to populate an individual's personal genetic profile assessment.

The genotyping data in FIG. 15 used to populate an individual's personal genetic profile assessment is generated from one or more biological samples of the individual. However, the one or more biological samples used in populating an individual's personal genetic profile assessment may also be taken from a different human or a non-human animal. In some embodiments, genotyping data is generated from one or more biological samples of a non-human animal. For example, an individual may supply biological samples of his or her pet in order to understand information about the pet's phenotype in order to assist in providing better care. The animal may be a pet or may be an animal cared for by an individual. For example, the individual may be a veterinarian or a caretaker at a zoo charged with caring for the animal. In some embodiments, genotyping data is generated from one or more biological samples of a ward to whom the individual is a guardian. For example, a parent may supply one or more biological samples to genotyping data for their child in order to improve his/her childrearing.

Certain embodiments of the present invention were described above. It is, however, expressly noted that the present invention is not limited to those embodiments, but rather the intention is that additions and modifications to what was expressly described herein are also included within the scope of the invention. Moreover, it is to be understood that the features of the various embodiments described herein were not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

Having described certain implementations of methods and apparatus for recording and tracking biological samples used to generate genotyping data, it will now become apparent to one of skill in the art that other implementations incorporating the concepts of the disclosure may be used. Therefore, the disclosure should not be limited to certain implementations, but rather should be limited only by the spirit and scope of the following claims.

1. A method for recording and tracking biological samples and biological material used to generate genotyping data, the method comprising:
receiving, by a processor of a computing device, a sample ID, wherein the sample ID is associated with a vial containing a biological sample and the sample ID is associated with metadata that identifies an individual;
assigning, by the processor, the biological sample to an empty well in a well plate, wherein the well plate is identified by a plate ID;
generating, by the processor, an anonymous vial ID, wherein the anonymous vial ID corresponds to one or more vials containing biological material that has been extracted from the biological sample;
associating, by the processor, the metadata with the anonymous vial ID; and
storing, by the processor, the anonymous vial ID for use in performing genotyping tests while obfuscating identity of the individual.

2. The method of claim 1, the method further comprising:
receiving, by the processor, for each of a plurality of anonymous vial IDs, a portion of the metadata, wherein the portion of the metadata identifies a genotyping test to be performed;
determining a genotyping plate to be used for performing the genotyping test based, in part, on a number of wells needed for the genotyping test, wherein the genotyping plate is identified by a genotyping plate ID;
associating, by the processor, the anonymous vial ID with the genotyping plate ID; and
storing, by the processor, the genotyping plate ID for use in managing genotyping test workflow.

3. The method of claim 2, the method further comprising:
receiving, by the processor, a list of genotyping plate IDs, wherein each genotyping plate ID corresponds to an unanalyzed genotyping plate;
presenting, by the processor, a graphical user interface element that displays the list;
receiving, by the processor, via a graphical control element in the graphical user interface element, input that indicates at least one genotyping plate has been analyzed, wherein the at least one genotyping plate corresponds to one or more genotyping plate IDs in the list; and
removing, by the processor, the genotyping plate ID from the list.

4. The method of claim 1, the method comprising:
presenting, by the processor, a graphical user interface element for recording a received biological sample, the graphical user interface element comprising:
a graphical control element for user entry of a sample ID, and
a plurality of individual metadata graphical control elements for entering information about the individual corresponding to the biological sample identified by the sample ID; and
receiving, by the processor, via the graphical user interface element, the sample ID and the metadata.

5. The method of claim 4, comprising automatically filling, by the processor, at least a portion of the plurality of individual metadata graphical control elements based on a profile registration of the individual; and

6. The method of claim 1, the method comprising:
automatically sending, by the processor, subsequent to receiving the sample ID, an email to the individual to communicate to the individual that the biological sample has been received.

7. The method of claim 1, the method comprising:
automatically sending, by the processor, subsequent to assigning the biological sample, an email to the individual to communicate to the individual that the biological sample is being processed.

8. The method of claim 7, the method comprising:
populating, by the processor, the email with one or more genotyping tests that will be performed for the individual.

9. The method of claim 1, the method comprising:
presenting, by the processor, a graphical user interface element for assigning biological samples to empty wells in a well plate in order to extract biological material from the biological samples, wherein the graphical user interface element comprises:
a graphical control element for user entry of a plate ID, and
a graphical control element for user entry of sample IDs;
receiving, by the processor, via the graphical user interface element, the sample ID;
indicating, by the processor, on the graphical user interface element, that the biological sample corresponding to the sample ID has been assigned to the empty well; and
indicating, by the processor, on the graphical user interface element, a number of empty wells remaining in the well plate.

10. The method of claim 2, the method comprising:
presenting, by the processor, a graphical user interface element for assigning biological material corresponding to an anonymous vial ID to one or more wells in a genotyping plate, the graphical user interface element comprising:
a graphical control element for user selection of a genotyping test, and
a graphical control element for user entry of a genotyping plate ID;
displaying, by the processor, via the graphical user interface element, a list of anonymous vial IDs and a list of genotyping tests associated with the list of anonymous vial IDs; and
receiving, by the processor, via the graphical user interface element, the genotyping plate ID.

11. The method of any one of claim 2, the method comprising:
determining, by the processor, one or more empty wells in the genotyping plate; and
indicating, by the processor, via a graphical user interface element, the location of the one or more empty wells in the genotyping plate.

12. The method of any one of claim 2, the method comprising:
automatically sending, by the processor, subsequent to determining the genotyping plate, an email to the individual to communicate to the individual that genotyping testing is being performed.

13. The method of claim 3, wherein the at least one genotyping plate has been analyzed when the genotyping plate has been tested and resulting data determined to be of sufficient quality.

14. The method of claim 1, wherein the genotyping test corresponds to a personal genetic profile product.

15. A system for recording and tracking biological samples and biological material used to generate genotyping data, the system comprising:
a processor;
a non-transitory computer readable memory having instructions stored thereon, wherein the instructions, when executed by the processor, cause the processor to:
receive a sample ID, wherein the sample ID is associated with a vial containing a biological sample and the sample ID is associated with metadata that identifies an individual;
assign the biological sample to an empty well in a well plate, wherein the well plate is identified by a plate ID;
generate an anonymous vial ID, wherein the anonymous vial ID corresponds to one or more vials containing biological material that has been extracted from the biological sample;
associate the metadata with the anonymous vial ID; and
store the anonymous vial ID for use in performing genotyping tests while obfuscating identity of the individual.

16. The system of claim 15, wherein the instructions cause the processor to:
receive, for each of a plurality of anonymous vial IDs, a portion of the metadata, wherein the portion of the metadata identifies a genotyping test to be performed;
determine a genotyping plate to be used for performing the genotyping test based, in part, on a number of wells needed for the genotyping test, wherein the genotyping plate is identified by a genotyping plate ID;
associate the anonymous vial ID with the genotyping plate ID; and
store the genotyping plate ID for use in managing genotyping test workflow.

17. The system of claim 16, wherein the instructions cause the processor to:
receive a list of genotyping plate IDs, wherein each genotyping plate ID corresponds to an unanalyzed genotyping plate;
cause presentation of a graphical user interface element that displays the list;
receive, via a graphical control element in the graphical user interface element, input that indicates at least one genotyping plate has been analyzed, wherein the at least one genotyping plate corresponds to one or more genotyping plate IDs in the list; and
remove the genotyping plate ID from the list.

18. The system of any one of claim 15, wherein the instructions cause the processor to:
cause presentation of a graphical user interface element for recording a received biological sample, the graphical user interface element comprising:
a graphical control element for user entry of a sample ID, and
a plurality of individual metadata graphical control elements for entering information about the individual corresponding to the biological sample identified by the sample ID; and
receive, via the graphical user interface element, the sample ID and the metadata.

19. The system of claim 18, wherein the instructions cause the processor to automatically fill at least a portion of the plurality of individual metadata graphical control elements based on a profile registration of the individual.

20. The system of claim 15, wherein the instructions cause the processor to:
automatically send, subsequent to receiving the sample ID, an email to the individual to communicate to the individual that the biological sample has been received.

21. The system of claim 15, wherein the instructions cause the processor to:
automatically send, subsequent to assigning the biological sample, an email to the individual to communicate to the individual that the biological sample is being processed.

22. The system of claim 20, wherein the instructions cause the processor to:
populate the email with one or more genotyping tests that will be performed for the individual.

23. The system of claim 15, wherein the instructions cause the processor to:
cause presentation of a graphical user interface element for assigning biological samples to empty wells in a well plate in order to extract biological material from the biological samples, wherein the graphical user interface element comprises:
a graphical control element for user entry of a plate ID, and
a graphical control element for user entry of sample IDs;
receive, via the graphical user interface element, the sample ID;
cause indication, on the graphical user interface element, that the biological sample corresponding to the sample ID has been assigned to the empty well; and
cause indication, on the graphical user interface element, of a number of empty wells remaining in the well plate.

24. The system of claim 16, wherein the instructions cause the processor to:
cause presentation of a graphical user interface element for assigning biological material corresponding to an anonymous vial ID to one or more wells in a genotyping plate, the graphical user interface element comprising:
a graphical control element for user selection of a genotyping test, and
a graphical control element for user entry of a genotyping plate ID;
cause display of, via the graphical user interface element, a list of anonymous vial IDs and a list of genotyping tests associated with the list of anonymous vial IDs; and
receive, via the graphical user interface element, the genotyping plate ID.

25. The system of claim 16, wherein the instructions cause the processor to:
determine, one or more empty wells in the genotyping plate; and
cause indication, via a graphical user interface element, of the location of the one or more empty wells in the genotyping plate.

26. The system of claim 16, wherein the instructions cause the processor to:
automatically send, subsequent to determining the genotyping plate, an email to the individual to communicate to the individual that genotyping testing is being performed.

27. The system of claim 17, wherein the at least one genotyping plate has been analyzed when the genotyping plate has been tested and resulting data determined to be of sufficient quality.

28. The system of claim 16, wherein the genotyping test corresponds to a personal genetic profile product.
